(19) United States
(12) Patent Application Publication
(10) Pub. No.: US 2011/0066948 A1
(43) Pub. Date: Mar. 17, 2011

(54) Method and apparatus for accessing and managing a multi-layered virtual server by deploying web folder tree

(76) Inventor: Sheng (Ted) Tsao, San Jose, CA (US)

(21) Appl. No.: 12/949,561

(22) Filed: Nov. 18, 2010

Related U.S. Application Data
(63) Continuation-in-part of application No. 11/374,302, filed on Jul. 2, 2004.
Application No. 11/374,302 is a continuation-in-part of application No. 10/713,904, filed on Aug. 6, 2002, now Pat. No. 7,418,702.
Application No. 10/713,904 is a continuation-in-part of application No. 10/713,905, filed on Aug. 12, 2002, now Pat. No. 7,379,990.
Application No. 10/713,905 is a continuation-in-part of application No. 12/079,482, filed on Mar. 27, 2008.
Application No. 12/079,482 is a division of application No. 10/713,904, filed on Aug. 6, 2002, now Pat. No. 7,418,702.
Application No. 10/713,904 is a continuation-in-part of application No. 12/944,958, filed on Nov. 12, 2010.
Application No. 12/944,958 is a division of application No. 10/713,905, filed on Aug. 12, 2002, now Pat. No. 7,379,990.
(60) Provisional application No. 60/402,626, filed on Aug. 12, 2002.

(51) Int. Cl. G06F 3/01; G06F 15/16

(52) U.S. Cl. 715/739

(57) ABSTRACT

The central controlled distributed scalable virtual machine (“CCDSVM”) of the present invention can be expanded across network domains such as Intranet and Internet, and thousands of systems in the virtual server can be organized into multiple groups (service pools) with a multi-layered hierarchy. The CCDSVM includes at least a control system to control and organize a management pool that comprising a plurality of middle level control systems, and each middle control system can control a service pool that comprising a plurality of system units. In addition, different privileged users can login different level of the control system to further centralized access the permitted system units in each pool. Specially, the present invention including a method of supporting of web folder tree and a method of supporting web based multi-tasking to enhance the manageability and operations of the CCDSVM.

### PRIORITY

This application is a continuation-in-part of the U.S. patent application Ser. No. 11/374,302, which is based on U.S. provisional Application No. 60/585,552. The application Ser. No. 11/374,302 is the continuation-in-part of U.S. patent application Ser. No. 10/713,904 (U.S. Pat. No. 7,418,702), which is based on U.S. provisional application Ser. No. 60/401,238. The application Ser. No. 11/374,302 is also a continuation-in-part of U.S. patent application Ser. No. 10/713,905 (U.S. Pat. No. 7,373,990), which is based on U.S. provisional application Se. No. 60/402,626. This application is also a continuation-in-part of the U.S. patent application Ser. No. 12/079,482, which is a divisional application of the Ser. No. 10/713,904. This application is also a continuation-in-part of the U.S. patent application Ser. No. 12/944,958, which is a divisional application of the Ser. No. 10/713,905.

### FIELD OF THE INVENTION

This invention relates to the methods and apparatus for a new user interface design by deploying web-based multi-layered items list (“web folder tree”) to manage and access information and system resources in a multi-layered central controlled distributed scalable virtual machine (“CCDSVM”) environment.

### BACKGROUND OF INVENTION

The computer user work environment (“CUWE”) has evolved from paper tape or punch cards of early years to the command line user work environment on the local system in the 1970's, and to the native window interactively selecting and clicking based user work environment in the middle of the 1980's.

Network-based user work environments have existed since the 1980's and 1990's such as Microsoft's terminal service, the Telnet of Unix & Linux system etc. that let users access and operate the target system from another system remotely. There are network management product, which primarily focus on monitoring the systems' network activities. In addition, these mentioned products and solutions have limited mobility and capability because they are required to install specialized software on the remote system and lack of portability.

There are web-based applications that allow users from a web browser of a remote system to access limited resources of a web server or device. There is web-based product that allows people to manage and access a web system remotely. However, they also do not create a web-based computer user work environment, instead, it dumps an existing computer user work environment of a particular web system to web browser on remote system. This type of system has many limitations, for example, during a web presentation the web browser can not display content of a file that exceeds 10 MB in size.

The idea of web-based computer user work environment (“WCUWE”) has been introduced in parent patent applications. The present application will focus on creating user interfaces (UI) of the WCUWE by utilizing multi-layered item list (MLIL) for providing a much flexible WCUWE for the CCDSVM, specially for the multiple layered CCDSVM. The WCUWE provides users to access and operate the systems of the CCDSVM from any conventional web browser of any system or electronic device. Due to the capability of expanding the CCDSVM across the LAN/WAN, Intranet and Internet and its strong security, the WCUWE actually provides an alternative solution for a more mobilized and flexible computational environment than the traditional native window or command line based user work environment.

### BRIEF SUMMARY OF THE INVENTION

The WCUWE for virtual operating system of the CCDSVM having support for web based multi-tasking and support for multi-layered CCDSVM has been disclosed in pending application Ser. No. 12/079,482 entitled “Concurrent Web Based Multi-Task Support for Control system”, filed on Mar. 27, 2008 in the name of the same inventor of present invention, and herein incorporated in its entirety. The method of automatically and dynamically provisioning and grouping one or more system units of the CCDSVM to form one or multiple service pools according to their functionalities in a cross-domain environment, the WCUWE for the virtual operating system of the CCDSVM, and a method for web based storage on-demand have been disclosed in pending application Ser. No. 12/944,958, entitled “Method and Apparatus for Web Based Storage On-Demand”, filed on Nov. 12, 2010 in the name of the same inventor of present invention, and herein incorporated in its entirety. Via the WCUWE, the CCDSVM is capable providing web based accessing, therefore, one or more service pools/groups of the CCDSVM can be accessed and managed via web-browser anywhere across a network. In addition, it permits and controls each of one or more users from a single web browser on a system or device to perform one or multiple concurrent tasks of accessing and managing the CCDSVM without blocking the web browser screen.

The mentioned tasks can be run and executed in the WCUWE of the CCDSVM include interactively selecting systems in the CCDSVM for performing task of storage configuration, storage volume allocation and de-allocation, storage partitioning and repartitioning, backup and restore for storage devices including RAID or SCSI or IDE disk drives; creating and mounting file system on the top of storage volume; and monitoring the selected system including the status of the system's storage, network, CPU, memory, processes/threads and other resources.

The mentioned tasks also include to move or transmit data such as for multiple gigabytes of file or other form of data form from any point or any system to another point or system within the CCDSVM. The authentication tasks also can be performed such as setup authentication for a specific user from a web browser on a specific system with certain privileges for accessing the entire CCDSVM or for one or more specific systems of the CCDSVM; setting up the authentication for users accessing specific services on one or more specific system units, hosts, or on the control system, and storing the authentication information in a form of a database on the control system. In addition, data can be managed such as creating file system, file and file-folder or directory structures, and accessing and managing file located either on the controls management system, system units or hosts of the CCDSVM including accessing applications and/or data services. The mentioned tasks and operations are compatible to those tasks can be run in command line or native window based user interactive work environment. Also, in present invention, the mentioned hosts are those systems in a service pool which are controlled by the control system although in one embodiment the host may also be called as a client of a system unit such as a client of a storage unit. The mentioned client systems are not controlled by the control system yet is permitted to access the CCDSVM.

Since the emergence of the native window & user interactive clicking based computer user work environment (CUWE), users are able to display, view and operate resources information of a computer system or devices by using multi-layered item list. For example, the files & folders list, email message folders, devices, folders and other resources on MS Windows system can be all conveniently accessed and managed via the multi-layered item list (“MLIL”). In other words, supporting multi-layered item list has become an important part of the native window based computer user work environment. However, let one or multiple concurrent users simultaneously display, view & operate multi-layered item list from each of a single web-browser for corresponding resources such as for deeply nested files & folders, or for multi-group, multi-layered provisioned systems in a virtual server or for various devices has became an big challenge. The mentioned prior applications together with the present invention have successfully solved such challenge by creating web-based user interfaces (“UI”) including mirrored MLIL for the WCUWE of the CCDSVM, where the displayed MLIL also can be called as web folder-tree.

These and other features, aspects and advantages of the present invention will become understood with reference to the following description, appended claims and accompanying figures.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating one embodiment of a CCDSVM layout with a central control system 2, one or multiple provisioned system units 3, hosts 17, and console systems 1. The CCDSVM supports each of one or more users from a web browser on the user's local system capable of accessing the CCDSVM, wherein the user's local system can be a control system 2, system unit 3, console system 1, host 17 or client system 10. The difference between the client system 10 and host system 17 is that the host 17 is controlled by the control system 2 in a controlled service pool while the users on the client system 10 are capable of accessing the CCDSVM yet the client system 10 itself is not provisioned and controlled by the control system 2. In addition, in the rest of discussions, all embodiments discussed for system unit 3 shall be applicable to the host 17, which means they will be treated similarly except the host 17 is permitted to access storage service from system unit 3 if the system unit 3 is a SAN or NAS unit without additional explanation.

FIG. 2 a) is a block diagram illustrating one embodiment of a variation of a CCDSVM layout only having a standalone control system 2 without any provisioned system unit 2, and can be accessed by users at the control system 2, client systems 10 and console systems 1.

FIG. 2 b) is a block diagram illustrating one embodiment of a variation of a CCDSVM layout with a central control system 2, provisioned system units 3 (which also has a native web-browser), provisioned host systems 17 or non-provisioned client system 10 (having a web browser for accessing), and console systems 1.

FIG. 2 c) is a block diagram illustrating one embodiment of a variation of a CCDSVM layout with a central control system 2, provisioned system units 3, provisioned host systems 17 (which is for non-web accessing), and console systems 1.

FIG. 3 is a block diagram illustrating the various pieces of the CCDSVM software modules residing on the central control system 2, provisioned system units 3, host systems 17, and console systems 1 in accordance with one embodiment of the present invention.

FIG. 4a) is a simplified diagram illustrating one embodiment of a displayed Multi-Layered Item List (MLIL) of a CCDSVM, where each node on the (MLIL) at a different layer may represent an associated physical resource.

FIG. 4b) is a simplified diagram illustrating one embodiment of a displayed Multi-Layered Item List (MLIL) of a CCDSVM, which consists a single node on the (MLIL).

FIG. 5a) is a simplified diagram illustrating one embodiment of a web-based pop-up menu associated with a disk drive node on a displayed MLIL that has two nodes for disk operation on the control system.

FIG. 5b) is a simplified diagram illustrating one embodiment of a web-based drop-down operation menu that can be used for selecting a system within said CCDSVM for further accessing.

FIG. 6a) is a simplified diagram illustrating one embodiment of a web-based pop-up operation menu designed for managing the storage node of a MLIL.

FIG. 6b) is a simplified diagram illustrating one embodiment of a web-based pop-up operation menu, which is associated with each of six nodes of a MLIL for file and file folder management, where each node is also bound and represented by a graphic image and name of a file or file folder. Therefore, when a user clicks on the file or file folder image of each node, the pop-up operation menu will pop up on the user's web browser and further allow the user to select a suitable operation option for performing management operations or tasks.

FIG. 6c) is a simplified diagram illustrating one embodiment of a web-based pop-up operation menu associated with a MLIL having three nodes at two levels for managing the control system and provisioned system units, where each node is bound with said pop-up operation menu and represented by a graphic image. Said operations could include, but not be limited to Shutdown system, Reboot system, System status including inquiry for the system status of CPU, memory, storage, network, etc., and Change Usage for changing server's usage from one purpose to another without limitations.

FIG. 7 is a simplified diagram illustrating one embodiment of a web-based displaying of provisioned system units, which were automatically & dynamically grouped by group ID and associated & represented by a MLIL with seven nodes at two levels. In one example, the group ID can be mapped to represent a type of service that a system unit actually provides. The group ID actually represents and is mapped to a specific type of service for a specific service pool.

FIG. 8 a) is a simplified diagram illustrating one embodiment of a web-based folder tree for displaying system groups, provisioned system units and their associated storage devices under a system group, which are associated and represented by a MLIL with three levels and six nodes.

FIG. 8 b) is a diagram illustrating one embodiment of a web-based folder-tree used for displaying system groups, provisioned system units and files & folders under a system group and system unit, which are associated and represented by a MLIL with three levels and 15 nodes, where each node is bound to an appropriate pop-up operation menu and graphic image representing said node.

FIG. 9 illustrates one example of how does the file system on the system units 3 in groups can be accessed. A user can interactively click a system group node on the top level MLIL (folder tree) to display one or more systems under the system group; then select and click a specific system node to display one or more file systems on the specific system; After one or more file systems on a system are displayed, the user can select and click on a specific file system node to display one or more file folders and files under the file system; The user can continue to select and click on any file folder node to access one or more next level file-folders and files as long as there is at least a next level physical resources of the files or folders. Meanwhile, the user can select any specific file or file folder and then right click on the selected file object to bring up the pop-up operation menu to further select a designated operation for performing a designated task, wherein in one embodiment, each file folder node bound with file folder operation menu, while file node bound with file operation menu.

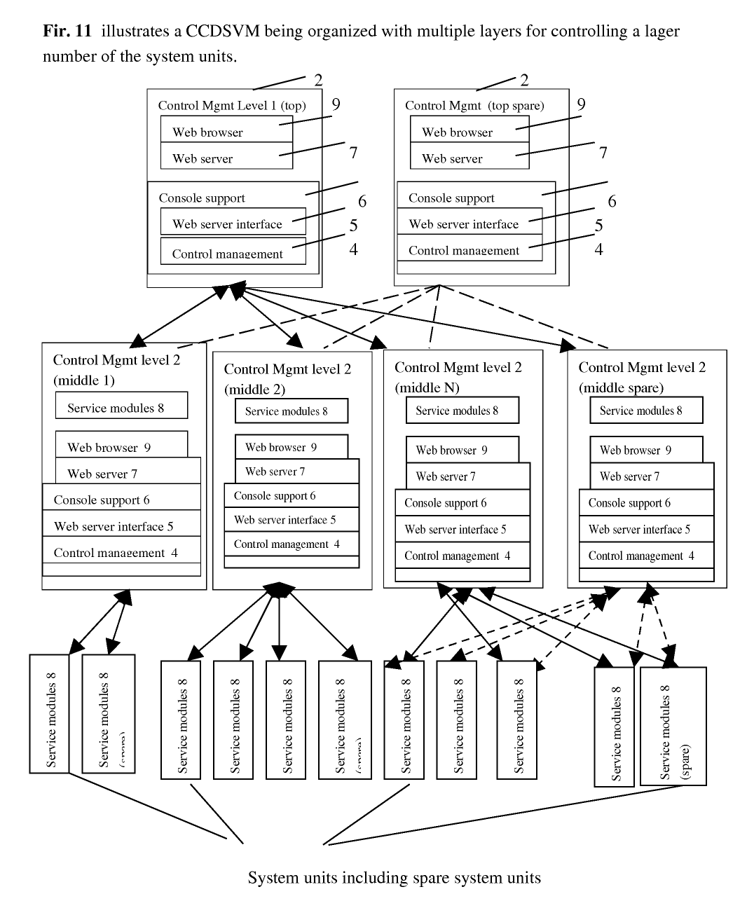

The illustrated FIG. 9 has displayed one embodiment of a control system and two system groups that are named marketing and engineering group. Each system group has one or more system units. Each system can be displayed with its one or more file systems, one or more file-folders/directories, and one or more files under each file-folder/directory. Also, a pop-up operation menu for file-folder/directory can be bring up when user right click on any file-folder/directory. In one example, the operating option includes “Add” a new file-folder/directory, “Rename” or “Delete” an existing file-folder, “Move From/Move to” or “Copy/Paste” for existing file folder, “Umount” to un-mount a file system from a mount point, and “Set ACL” to set accessing permission on file-folder to be accessed by one or more designated users. In another embodiment, the files under a file folder on a system unit in the group engineering are displayed and each file also displayed with attributes of name, size, and time stamp. Also, the operation menu for file can be bring up upon user right clicks on the file name, and an operating option can be selected, and further the task can be submitted.

In all embodiments of the illustrated MLIL, said operation menus, and graphic images are encoded into web page for displaying in web browser with any suitable or combination of suitable programming languages such as C, C++, Java, Javascript, HTML, XML, WML and so forth without any limitations.

FIG. 10 illustrates a typical a computer system for either a control system or a system unit or a host of present application that is connected to a network infrastructure including routers and switches. A control system can control a plurality of system units that forms a service pool, which includes at least a spare system unit for providing fault handling and each spare system unit can service at least a operational system unit for providing fault replacement handling.

FIG. 11 illustrates one embodiment of a multi-layered CCDSVM structure. There are 3 layers in the figure. Nevertheless, a CCDSVM with more layers are also possible and it shall work the same way as 3 layers of the CCDSVM without limitation. For one example, placing a middle level control system at third level, therefore, it can control a fourth level service group of one or more system units and/or middle level control systems and each fourth level control system can control another level of systems and so on without limits. The number of layers of the CCDSVM is really depending on each organization's needs.

With this layered structure, the system units 3 and/or hosts of the CCDSVM can be sub-divided into different groups (service pools); where each group comprises at least a system and is controlled by a control system sitting above the group of system level and can be accessed via the control system. In addition, each service group comprises at least a middle control system except for the service group at lowest level which may only includes system unit 3 or host 17. With this layered CCDSVM, each middle control system can have dual roles as a control system 2 and as a system unit 3 (or host 17). For one example, a level-2 middle control system is a control system 2 for all systems below its level and functions as a system unit to the level-1 control system. Therefore, the middle level control system must have related software modules for both the control system 2 and system units 3 for providing compatible functionalities; for example, it must have service modules 8 of system unit 3 for communicating to its up level control system and must have the console support modules 6 of the control system 2 for communicating to and controlling all the systems bellows itself as illustrated in FIG. 11. Also the control system at each level keeps a system unit information list for its immediate next level systems, where the information list including each system's identification information such as name, IP address, configuration information such as storage and network devices, and data information including service information for providing corresponding service.

### DETAILED DESCRIPTION OF THE INVENTION

Embodiments of the present invention are described herein in the context of the methods and apparatus for a new web user interface design by creating web-based multi-layers items list (web folder tree) and using it to manage and manipulate information and resources of the CCDSVM in the web-based computer user work environment (WCUWE). Those of skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time consuming, but would nevertheless be a routine undertaking of engineering for those of ordinary skill in the art having the benefit of this disclosure.

Every computer system provides end users a computer work environment (CUWE), which usually runs on top of a generic computer operating system on the user's local system. The CUWE allows a first privileged user to setup user account profile for one or more other privileged or regular users, to configure resources of storage, network, file system, file folders structure, files and all other available hardware or data resources on a system, to monitor system activities, to access applications, and to manage and access data files such as moving data from one folder to another folder or moving data from one system to another system, and to send or receive messages for communication etc.

Additionally, the CUWE provides each user with limited permitted resources such as owning and accessing default file-folders on a file system, and other resources.

The CCDSVM is an abbreviation for central controlled distributed scalable virtual machine. The CCDSVM allows a control system 2 to control one or more groups of systems to be operated like a single machine. In one embodiment the CCDSVM provides distributed applications services to a plurality of end users at each of their local system or device across Intranet and Internet as well as in LAN/WAN and in another embodiment one group of systems in the CCDSVM can provide services to another group of systems in the CCDSVM. For example, each storage unit in a storage service group can providing storage service to a plurality of hosts in a video service group while each host providing video service to its end users across Internet. In one more embodiment, The CCDSVM permitting a plurality of user login the CCDSVM for performing various tasks of accessing and/or managing permitted one or more resources on one or more permitted systems of the CCDSVM, wherein the tasks are compatible to those can be performed on the native CUWE on the user's local system that were mentioned in prior paragraphs.

The software components of the CCDSVM form the virtual web based computer user operating environment (“WCUWE”), which includes console support software modules 6 and web server software modules 7 running on the top of the operating system (“OS”) kernel of the control system 2 (the controller part of the WCUWE), and includes service modules 8 running on the top of OS kernel on each system unit 3 or host 17 of the CCDSVM (the agent part of the WCUWE). The WCUWE controller on the control system 2 communicates to the WCUWE agent on the system unit 3 via communication links of a network infrastructure for controlling the user space operations of the CCDSVM. In present invention the virtual operating system for the CCDSVM really includes two layers that is WCUWE layer and OS kernel layer.

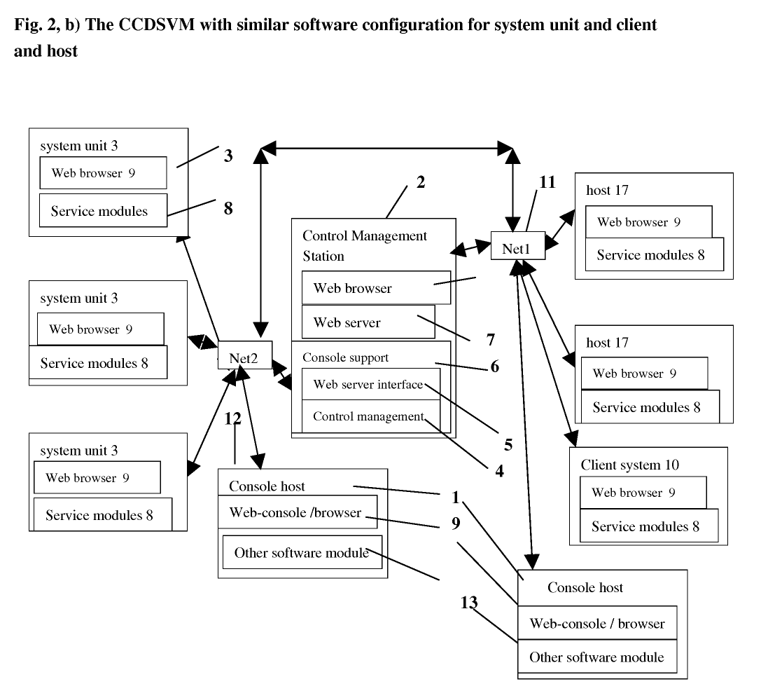

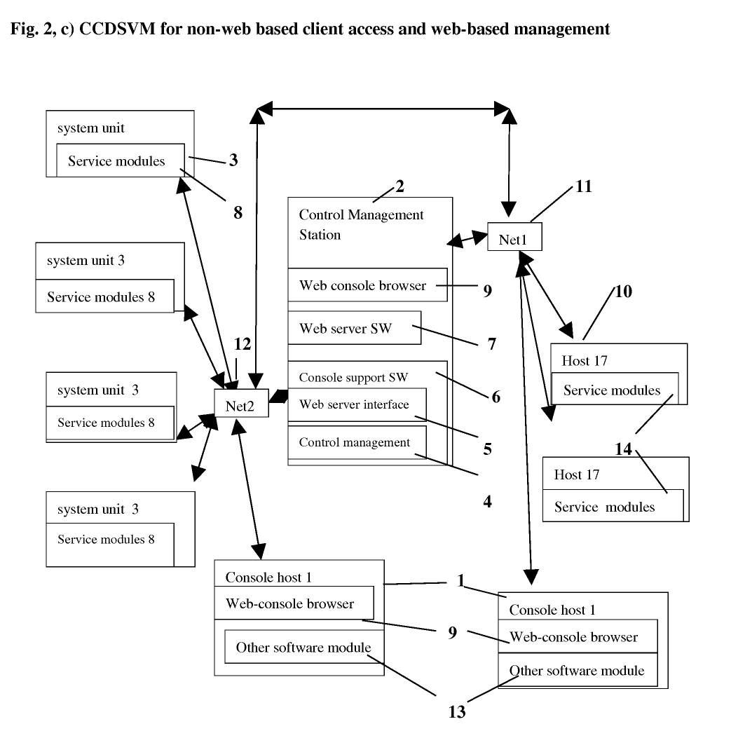

The web-based computer user work environment (WCUWE) of present invention is also for a single computer. For example as illustrated in FIG. 2a), a control WCUWE controller alone on a standalone control system 2 runs on the top of the native operating system kernel of the control system 2. The WCUWE of present invention tries achieving the compatible functionalities provided by the system's native CUWE, for example, supporting the tasks that are compatible to the tasks can run on the native window based or command line based user work environment. In addition, the WCUWE controls each user from a web browser on the user's local (native) system log on the control system and capable of further submitting one or multiple concurrent tasks to be run without blocking the web browser screen.

Also, in one embodiment, the control system controls the support maximum number of concurrent users to access the CCDSVM. In one example, if supporting a user login session requires an average of 2 Mbytes of memory and 512 Mbytes of storage, then to support 300 concurrent users on a system roughly requires at least 600 Mbytes of memory and about 150 GBytes of storage space.

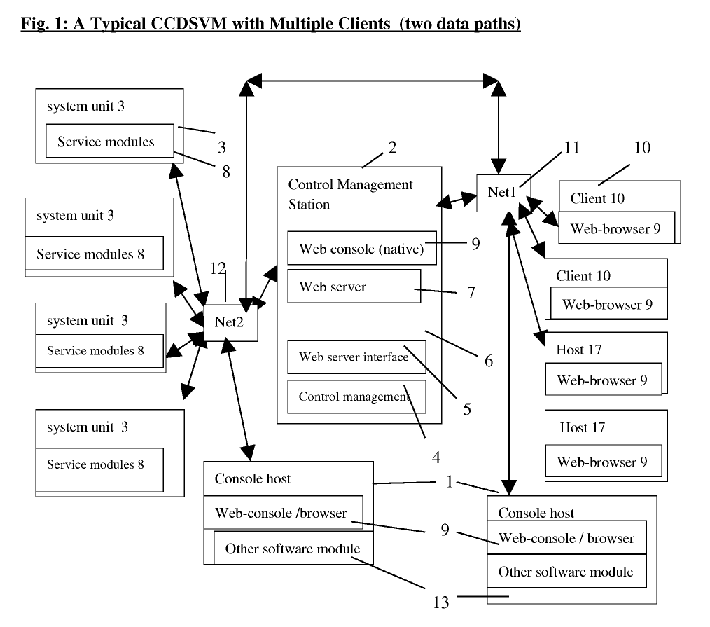

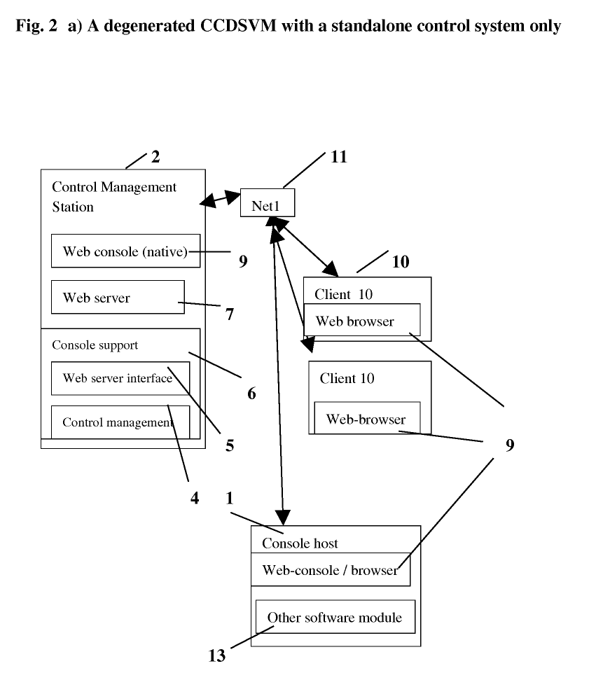

Said user's local system can be a remote system such as a laptop, desktop, and server system, or a wireless personal communication device such as PDA, cell phone, etc. that can be the control system 2 itself, the system unit 3, the host 17 or client system 10 as illustrated in FIG. 1. In one embodiment, each system unit 3 can have its own WCUWE, and the WCUWE of each system unit can be either accessed via the WCUWE of the control system and can be accessed independent of the control system 2 With the WCUWE the entire CCDSVM system can be operated like a single machine.

The WCUWE of the control system 2 is capable providing web hosting. In one example, the control system 2 is capable of hosting a virtual block data server (virtual SAN) web site to perform administration tasks and distribute each host's storage volumes requests to specific system units 3 up to the maximum storage volume requests that each block data system unit 3 can handle. In another example for the IP based distributed virtual SAN (virtual block data server), the control system 2 maintains a list of information from each SAN units 3, which will be the list of storage volumes where each entry on the list comprises information of the specific type, size, address of the block data as well as the IP address of each block data system units.

In third example, the control system 2 hosts a virtual video server web site to perform administration tasks and distribute each user from client system's video requests to the specific video system units 3 up to the maximum concurrent video requests that each video system unit 3 can handle. Here, the client system 10 can be a system or device having a display for display video streams, which could be a laptop or desktop system or a wireless personal communication device or a TV unit capable of connected to a communication network including world wide web for example via Ethernet to ADSL router. In fourth example of distributed video server system, the control system 2 maintains a list of video files information from each system units 3.

In one embodiment, the control system 2 controls one or multiple service pools (groups), wherein the service pool can be SAN storage volume service pool, NAS file system volume service pool, or host service pools such as video service pool, security monitor service pool, file service pools, web service pools, database service pool and other service pools that provided services across the web (or network) without limits. Therefore, the control system 2 capable of hosting a web site of the CCDSVM for privileged users to perform administration tasks for resources of multiple service pools. For example, performing admin tasks for each host 17 in a service pool capable of using storage volumes on one or multiple storage units 3 in one or more storage pools (SAN storage pool and NAS storage pool), therefore, each storage unit 3 is capable of providing storage services to multiple hosts 17 while each host 17 provides its own services to multiple end users or client systems. Additionally, in one topology layout, the multiple service pools can be organized into multiple layers and having multiple control systems at top and at middle as illustrated in FIG. 11.

For the clarity of discussion, several technology terms are clarified hereafter. First said resources on each mentioned system can include hardware and data resources. The hardware resources on a computer or electronic device could include the plurality of CPU, memory, storage device, network device, monitor or other display devices, keyboard, mouse, photo or video and audio recording and playing back devices, wireless device etc without limits.

The data resources include various forms of deposited data or information on storage such as user accounts & security profiles etc. The deposited data on storage could be in a form of raw data or file system structure, which includes the file-folders, data files or application program files, structured or unstructured data etc. without limits. The data files can be media data of streaming video or audio files including MPEG or AVI file, or image/photo picture data in various forms; document file such as MS Power Point or Word or spreadsheet documentation, PDF file, or text files and so forth without limit. The data files also includes records file, for example, in one embodiment, the message records file can contain one or more messages, and each message including multiple fields that comprises the information of sender, receiver, message body, data time, attachments of files or pictures.

In another embodiment, the multiple user account and authentication profiles also can be stored as a record file. The mentioned storage can be hard disk drive, magnetic tape drive, various forms of memory devices, or others suitable media. In addition, said resource also includes network resources such as the identification information of the name, IP address, ID, type of one or more systems on a network and the information of each system group (pool) etc. The mentioned resource, storages, and deposited data and information are for illustration only, which shall have no limits in this application.

The mentioned web browser can be the conventional web browser that is used to access the information hosted by a web server and can interpret the standard structured format (formatted information) and display them via web pages. The web page can be encoded with any suitable or a combination of any suitable programming languages such C, C++, Java, JavaScript, HTML, XHTML, DHTML XML, WML without limits such that people can view, manipulate, and interact with the displayed information. The contents of a web page will be updated by the server software on a server system such as the control system 2.

The multi-layered item list (MLIL) is a logically organized information list with a certain order, where each entry contains an item and each item may contain another layer of listed items, where each items may represent a physical resource or information of the computer systems or devices and represent the information for various application and services. For example, the information of files and file-folders of a file system or email folders on a modern computer system typically can be represented as multi-layered item lists and can be viewed, displayed & operated on a modern UI window on the local system such Microsoft Windows system, where each item (node) on the list may represent a folder or file. The information of systems or devices on the network, the information of hardware components on a system such as disks, network cards, memory etc., and the information of multiple user accounts on a system also can be organized into multiple layers of item lists for displaying, viewing, and operating. The support of the MLIL in the WCUWE makes the system resources and information much easy to be displayed, viewed, and operated from a web browser. Each web page provided by the WCUWE of the CCDSVM may contain one or multiple MLIL and each MLIL may contain at least one or more items (nodes).

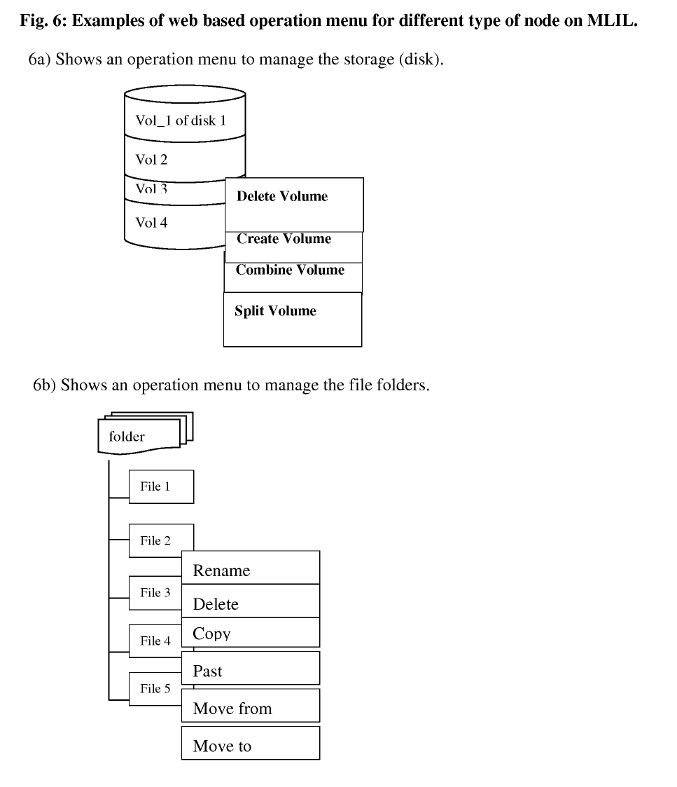

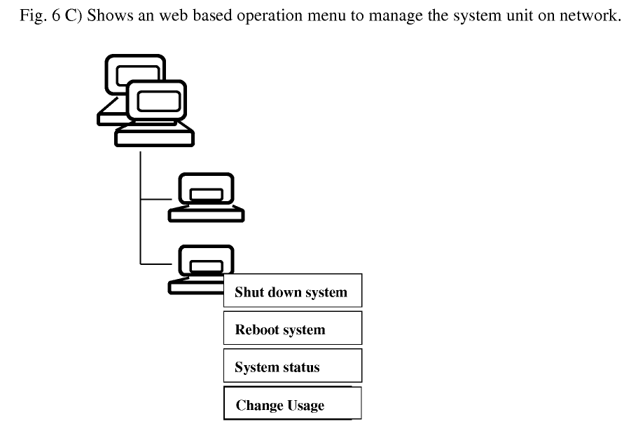

In order to display a MLIL into user's web browser, a mirrored MLIL for a MLIL must be created in the memory for reflecting the MLIL and for easy manipulating the MLIL, and the mirrored MLIL then needs to be encoded into a web page upon user's request of accessing a resource related to a MLIL. For example, if a user is assigned to access a file folder, then after the user's login to the control system 2 via a login web page, the user will see a displayed file folder symbol on a web page in the web browser. Further, upon the user's interacting on the displayed file folder symbol, a MLIL is displayed with the next level of one or more sub file folders and files via an updated web page as illustrated in FIG. 6 b). That is similar to the Microsoft's file and folder management on Windows via window explore. This has indicated that a mirrored MLIL has been created in the memory of the control system for a file folder MLIL that represents a physical file folder, and the mirrored MLIL is encoded into the updated web page which is transmitted to and displayed in the web browser. For the convenience of the discussion, many times the MLIL, mirrored MLIL and the displayed MLIL are simply referred as the MLIL without differentiation.

All systems mentioned in present invention, are computational system and devices that include desktop and laptop system; various types of servers such as web servers or database servers or email servers or video/audio servers or storage server including NAS (network attached storage) and block data server (SAN), file server, or web application servers; and include communication device such as wireless PDA, or cell phone or other devices with communication ability, computational resources and native operating system (OS). Each mentioned system and device is configured with one or more local file systems on top of one or more storage media for storing data. The mentioned systems are just for illustration only without limits.

The mentioned OS running on a local system can be any suitable operating system such as Windows, Linux, various Unix, real-time operating system and so forth without limits.

The mentioned programming languages, which are used for implementing all software modules mentioned in this application, could be any suitable languages or a combination of the suitable languages, which includes C, C++, Java, JavaScript, Visual Basic, C sharp, HTML, XML, DHTML, XHTML, and so forth without limits. In the real life, programming languages such as HTML, XML . . . themselves are often unfortunately referred to as standard format for web instead of as a language. In other words, they are often be used interchangeably in this invention without further mention of the differences.

The communication protocols used in the CCDSVM could be any type for transmitting required data over communication links, and they can be IP-based protocols or non-IP-based. The IP based protocols are built on top of IP protocols including standard protocols such as TCP protocol, UDP protocol, ICMP protocol, and others, and they also can be non-standard proprietary protocols. The non-IP based protocols can be ISO 8473, ISO 8208, or serial communication, or data link layer protocols like LLC 802.2, or HDLC, or any proprietary protocols bellow the IP protocol level. The communication protocols for web computing could be HTTP, HTTPS, SOAP, WAP, or others without limits. Furthermore, the languages and protocols mentioned above are for illustration only, which do not impose any limitation.

The web browser mentioned in this invention may be an existing commercial software from any vendor such as Microsoft IE or Netscape, or Firefox, or Mozillar, or any other commercial or proprietary software. The web browser is a special network application software, which communicates with web server through protocols such as HTTP, HTTPS via a network or inter-process communication. The web browser must be able to interpret the web protocols such as HTTP, HTTPS, SOAP, WAP or others and be able to interpret the standard structured formatted information and must further to let users to view and interact with the contents on a web page. The conventional web-browser and protocols described here are just for illustrating purpose only, and other web browser and protocols are all possible and are not limited in present application.

The web server software mentioned in this application could be a commercial software from any vendors such as Apache, IIS, or others on the market, and it also can be a proprietary software without limits. The web server software must be able to handle web protocols such as HTTP, HTTPS, SOAP, WAP and all other suitable protocols. If the web-server software and web-browser are located on different systems, the structured information (encoded into web page) from the web server can be transmitted to the web browser over communication link across a network; if both web server software and web-browser are located on the same system, the structured information from the web server software can be transmitted to the web browser over inter-process communication.

A user session with a web system is normally started at the time the user logs on (logs into) a web system from a web-browser and ended at the time the user either voluntary or non-voluntary logs out/off of the web system from the same web browser that the user had logged on/into previously. During a session, users can perform permitted tasks.

FIG. 1 illustrates an embodiment of a CCDSVM platform, which includes console systems 1, control system 2, provisioned systems 3, host 17 and networks 11-12, wherein networks 11-12 are used for inter-connecting all systems of the CCDSVM and client systems 10. In one embodiment, the CCDSVM can reside in a corporate Intranet and providing web based secure accessing for the corporate users either inside corporate or from world wide web, or for the users from another partner corporation. In another embodiment, the CCDSVM resides inside of a corporate Intranet or datacenter can also host web site for providing web services for public users' accessing.

Console system 1 of the FIG. 1 is a computational system having a web-browser (web-console) 9 to be used by privileged users for accessing and managing the CCDSVM platform. The web browser 9 in one embodiment, permits a user to access information of the CCDSVM by following a web URL link for a web page. For example, a privileged user enters a URL address of “https://69.107.28.123/stt/sttwebos” on a command line of the web browser 9 and once the communication link is established, the user can obtain the information provided by the WCUWE via web page on the control system 2, where the WCUWE facilitates web pages for displaying all necessary information of the CCDSVM for each user interactively accessing the CCDSVM. The Console system 1, in one embodiment, further includes software modules 13, wherein modules 13 may be used to facilitate communication between the console system 1 and the control system 2 using any suitable communication protocol, in one example, it may facilitating non-web based communication for non-web based console user interfaces (“UI”).

The control system 2, in one embodiment, could be any system with proper computational capacity, resources and suitable OS for controlling the systems in the CCDSVM. The control system 2 includes web server software 7 and console supporting software 6. The console supporting software 6 includes web server interface software modules 5, which are dedicated to communication with web server software 7 through inter-process communication, and includes control management software modules 4, which are dedicated to communicate to service software modules 8 of the provisioned system unit 3 to further control and manage each provisioned system unit 3. In the rest of the discussion, the console support software 6 will be used instead of further mentioning web server interface software module 5 and control management software 4 since they both are part of console support software 6.

The console support software 6 of the control system 2 is capable of accepting requests, in one embodiment from each user's web browser 9 on the user's local system across a communication link, and in another embodiment accepting requests from each client or host 17; further, the console support software 6 identifies a system unit 3 or a host 17 that configured with the requested service and/or data and having capacity and bandwidth for providing the requested service; finally the console support software 6 of the control system 2 distributes the request to the identified system unit 3 and let the identified system unit 3 provide the requested service via communication link directly to the requested client 10 or host 17 or to each requested end user's web browser on the end user's local system independent of the control system 2 and other system unit 3. In another example, the console support software 6 of the control system 2 distributes the request to the identified host 17 and let the identified host 17 provide the requested service via communication link directly to the requested client 10 or to each requested end user's web browser on the end user's local system independent of the control system 2 and other hosts 17. As matter of the fact, the console support software 6 maps a fixed number of requests to each specific system unit 3 or host 17 up to the maximum number of concurrent service data that the system unit 3 or the host 17 can provided.

In one example, the end user or the client system 10 or host 17 can directly access the resources on the identified system unit 3 after an authentication process based on mapping information between the identified system unit 3 and the end user or client system 10. in another example, the end user or the client system 10 can directly access the resources on the identified host 17 after an authentication process based on mapping information between the identified host 17 and the end user or client system 10. The mapping is created and maintained by the control system 2 and including requester's identification information such as name and IP address, the requested object information such as type and size of the object, and the assigned and identified system unit's identification information.

The control system 2 may also have a native web browser (web-console) 9 for user local to the control system to access and/or manage the CCDSVM. The web browser 9 communicates to the console support software modules 6 and the web server software modules 7 through inter-process communication. In the present invention, the inter-process communication is extensively deployed between the mentioned modules that resided on the same system.

The web server software 7 sends data to and/or receives data from the web browser 9 on said user's local system by using any suitable protocols such as HTTP, HTTPS for web contents delivery. The web server software 7 and console supporting software 6 can be implemented with any suitable or a combination of suitable programming languages. In addition, the communication protocol used between the console support software 6 and the service software modules 8 of the system units 3 could be any suitable protocol. The web server interface 5 of the console support software 6 may be extended to provide service the same as the web server 7 provides, and in this case there is no need for web server 7 software. The mentioned software modules such as console support software 6 comprise the sequences of the computer executable instruction code to be loaded and executed by the CPU on the respective systems of the CCDSVM.

System unit 3 could be storage server including block data server (SAN unit) and network attached storage (“NAS”). The system unit 3 (and host 17) also could be any system with proper said computational resource and OS such as desktop and laptop PC, wireless device including hand held PDA, cell phone, server system including video server, web server, file server, email server, database server, video security monitoring device etc without limits. The system units 3 and host 17 can be automatically provisioned by the control system 2 based on a variation of automatic system service pool (group) construction protocol described in prior application of Ser. No. 12/944,958. Provision process of present application, also known as pooling process, is a method allowing a control system 2 to control a pool (group) of one or more networked systems via the configuring the networked systems.

In one embodiment, the control system automatically detects each system such as a system unit 3 or a host 17 goes online and then obtains identification, configuration and data information from the system across a network infrastructure, which can be one of corporate Intranet, Internet, LAN or WAN, and which also can be a corporate storage network. Further, the control system 2 will store the obtained information from each system into a system information list.

In another embodiment, when each system such as a host 17 or a system unit 3 boots up a packet is sent to a designated control system by the system via a communication protocol between the console supports software 6 of the control system and the service modules 8 of the system; from the received packet the console support software 6 of the control system 2 obtains, and stores the system's identification information including name, ID such as group ID, IP address etc; next the console support software 6 of the control system 2 assigns the system into a corresponding service group based on its group ID or service type, and then ask the system further providing service information via a response packet. The service information includes system configuration and data information such as network information, storage information, file system information including data file and application program file and other resources information without limits. Finally upon receiving the response, the mentioned resources information of the system will be stored into a system information list on the control system 2. Therefore, each provisioned system can be monitored, accessed, and/or operated by privileged user(s) through the web-browser 9 of the user's local system via the system information list on the control system. The above automatic sequence of steps for constructing a service pool is repeatable for all systems and can be applied for all system groups (service pools) of a CCDSVM regardless it is multi-layered structured or not in present invention.

The system unit 3 and host 17 can be dynamically added into or removed from a service pool based on the capacity requirement of the CCDSVM without interrupting the normal operation of the CCDSVM; and in one embodiment via boot or shutdown one or more system units; in another embodiment adding one or more spare system units in response to a control system 2 monitoring and detecting each system in a pool have reach its maximum service capacity.

Each system unit 3 comprises service software modules 8, which is capable of communicating with the outside of world. In one embodiment, the service software modules 8 of the system unit 3 can communicate with the console support software 6 of the control system 2 to carry out the requested tasks for viewing, monitoring or operating for the resources of the system unit 3. In another embodiment, after receiving a client 10 request that distributed by the control system, the service software modules 8 of the system unit 3 also can communicate with client 10 to deliver data and services to each client directly without going through the control system 2 again and independent of other system unit 3;

In addition, for one example, the service software modules 8 of a system unit 3 provides response to a user's request of accessing a specific video file or application; in another example responding to a request from a host 17 for a specific sized storage volume such as a specific sized SAN block data storage volume or a NAS file system volume; in third example, the request for SAN block data storage volume from a driver routine on the host 17. In one more embodiment, a system unit 3 can communicate with other system unit 3 to send or receive data etc. in response to specific tasks performed by the administrator at a console system 1 via web UI, for example transferring one or more files including multiple Giga bytes sized file from one system unit 3 to another.

The service software modules 8 of the system unit 3 may include an individual software module having compatible functionalities of web-server software 7 of control system 2 and dedicated to handle HTTP, HTTPS protocol or other suitable web protocols if there are needs for web-based communication with client 10 or host 17 or console system 1 or other system unit 3 or control system 2. Said individual software module could be commercial web server software on the market or a proprietary software. The service software modules 8 could be implemented with any suitable or a combination of suitable programming languages; Also, the communication protocol used by service software 8 could be any suitable protocols.

Each system units 3 uses a network interface for communication with the control system 2 and the clients 10 via a communication network (11/12). An example is IP/Ethernet connection, wherein the IP switches/routers are used to deliver the data streams from the system units 3 to clients 10 such as personal computers via the Internet (IP Internet connection). Other suitable connections include e.g. Ethernet to ADSL router to deliver the data stream from system units 3 to TV units with a set Top box via e.g. cable. Other network interfaces such as Fiber optical interface for Fiber Channel connection are also possible and contemplated by the present invention, for example a system unit 3 is a fiber channel SAN unit to deliver storage volume (block data) to IP connected host 17 via fiber channel to IP gateway. Other services can be provided by the system unit includes but not limited to video, web, database and security monitoring service.

In one embodiment, if the control system 2 is configured with multiple network interfaces for example a Ethernet and a wireless network interface, the console support software 6 detects from which network interface the requested data stream is coming from, therefore, it will provide the response back to the sender via the same communication link that includes the identified network interface. In one case, a web browser 9 on a user's local system send a request via Ethernet interface on the control system 2 is identified, therefore, the console support modules 6 of the control system 2 will send the response web page back to the web browser 9 via the same Ether net interface.

In another embodiment, the CCDSVM can reserve one or more system units 3 in a service pool as illustrated in FIG. 11 for providing a central controlled fault handling functionality. Each mentioned spare system unit 3 may stored with data and application service programs that may be identical or compatible to the data and applications stored on at least a non-spare operational system unit in the same service pool to provide dynamic data and service replacement for the non-spare system units 3 in an event that if the control system 2 detects any non-spare system unit having a fault occur. Un like the mirrored system, each spare system unit can server multiple non-spared system units 3.

In one more embodiment, the spare system unit 3 can be combined with popular practice of mirrored pair of system units in a topology layout for a service pool in the CCDSVM, where one or more pair of system units are mirrored such as a mirrored pair of SAN units and a spare SAN unit can service the fault handling if all SAN unit in a pair having fault. One spare system unit 3 can serve one or more pair of SAN units while a mirrored system unit 3 only can providing fault replacement for another system unit 3 in the same pair. In a similar embodiment, a spare host 3 can be deployed for providing fault replacement service for a plurality of host 3, in one situation the plurality of host 3 are arranged as one or more mirrored pairs.

Net 11 and Net 12 are network infrastructures that are capable of providing communication links between the control system 2, console system 1, client system 10, host 17, and/or provisioned system units 3. The net 11 and net 12 may consist of connection media such as cable (Ethernet, optical Fiber, and other), wireless media for wireless link through the air, data bus on the circuit board, and it also comprises one or more communication equipment such as switches, routers and adapters, etc. and all other possible elements of communication equipment without limits.

The number of the system units 3 and switches/routers depends on the bandwidth required of the CCDSVM. For example, in a switch connected to a 1-Gitabit Internet port for client connection, and to eight or twelve 100-bit of system unit ports, each system units 3 is configured with 100-bits/sec Ethernet card. A data transfer forwarder sends information to the corresponding 100-bits port for each system units 3. The number and type of switches further depends on the number of system units 3 connected to each switch, and data streaming bandwidth and rate requirements. The example switches or routers are manufactured by Cisco™ and 3Com™.

In one embodiment, the Client systems 10 may not be a part of the CCDSVM, however, they are treated equally the same as Console system 1 because with the permission and authorization, users from the web-browser 9 of the client system 10 can login to the CCDSVM and access the permitted resources of the CCDSVM. For one example, privileged users from a web browser through displayed WCUWE via web user interface (“UI”) can perform tasks of obtaining, managing, accessing and/or operating system resources of the CCDSVM, regular (non-privileged) users at the client systems 10 may be permitted to access only limited system resources of the CCDSVM such as assigned personal file-folders or message folders. Also, a request (task) is generated and sent to the control system 2 upon a user from the web browser 9 on a system such as client system 10 interacting to the CCDSVM.

In another embodiment, a host system 17 in a service pool of the CCDSVM when a control system 2 controls at least a service pool of a plurality of hosts 17. For example, the CCDSVM can have at least a control system for controlling multiple service groups (pools) which can include multiple storage and application service pools, where each application service pool includes a group of hosts 17. In addition, while each host 17 providing its own service to its end users at remote client systems 10 that are not controlled by the control system 2 and may not shown in the figures of present application, the host system 17 is also capable of utilizing the storage service provided by the storage system unit 3 in the storage pools such as SAN block data service or NAS file system volume service. Therefore, the control system 2 provides a centralized control for both the storage system units 3 and host system 17.

In one situation, each storage system unit 3 can provide multiple service streams to multiple host systems 17 and each host system 17 can request and utilize storage volumes on storage devices of at least a storage system unit 3 (SAN or NAS unit) in addition to access its own storage device. Actually, each service pool of the CCDSVM is organized by their service type and in one embodiment the type is mapped to a service group ID. In another situation, multiple service pools of the CCDSVM can be organized in a multi-layered hierarchical structure as discussed before and depicted in FIG. 11.

In addition, in one example, the control system 2 keeps mapping information in its system information list in response to each requested service. In another example, the mapping includes which host 17 accessed what sized storage volumes on what storage unit 3 (SAN or NAS unit) in a storage pool. The control system 2 adds the host 17 into the map along with a designated system unit 3 upon the accepting of the host 17 requesting to access the designated system unit 3. The control system 2 will remove the host 17 from the designated system unit 3's mapping once the system unit 3 has finished deliver the data or service to the host 17. In another similar example, the mapping includes the information of each user's local system or a remote client system 10 and a identified video server's (a host 17 or a system unit 3) name, IP address and the requested video, where the identified video server capable of providing video service.

In another situation, an administrator can manually assign a storage volume on a SAN unit to a host 17 for accessing based his/her admin knowledge, hence the information will be added to a mapping. In another situation, a mapping can keep information for which user from where is permitted accessing what files on what file server units 3 in a file service pool. The mapping information are synchronized across the communication links between the related parties, for one example, between the control system 2, the host 17, and the system unit 3 in handling storage request from host 17, therefore, after synchronization, an authentication process can be executed between the host 17 and the storage unit 3 based on the information in the mapping. For another example, the mapping information are synchronized across the communication links between the control system 2, host 17, and a user's local system for the mentioned case of video request.

The CCDSVM configuration, in one embodiment, includes four data paths. The first path is the data flow through the communication links between the web browser 9 on a user's local system such as the client system 10 or console host 1 or control system 2, or system unit 3 or host 17, and the web handling software on the control system 2 such as the web-server 7 & console support software 6. With this data path, whenever a user sends a request from the web-browser 9 to the web-server 7 and further down to the console support software 6, the console support software 6 will provide a response to said request by collecting all required information from the target system and convert them into standard structured information (encoded into the web page for displaying) by using any suitable or a combination of suitable programming languages such as C, C++, Java, Javascript, HTML, XML, WML etc. without limit for web communication.

The request may be also non-web based, for one example, a host system 17's a driver routine could send a request for a specific sized storage volume to the control system 2, therefore, the console support software 6 of the control system 2 identifies a targeted storage system unit 3 that configured with the requested sized storage volume for providing the requested service such as SAN block data volume service or NAS file system volumes service etc. based on collected information on the control system 2, and further distribute the request to the identified storage unit 3. Upon receiving a response from the console support software 6, the identified storage system unit 3 can provide the storage service directly to the requested host 17 without going through the control system 2 again after a authentication process with the host 17.

The targeted system could be any system unit 3 or the control system 2 itself. The information can be collected for said response by the console support software 6 of the control system 2 depends on the request type, which could be resource or status information including each targeted system's the storage information, or network information, user authentication profile, file system information or files & folders information, or a status of a task execution, and without limits. Actually, the console support software 6 can provide a response at anytime after receiving said request independent to the actual task result based on the application's needs, where said response could be the status of said task executing such as failed or finished or in progress, or the actual result of said task executing or the location of the task result. The console support software 6 will encode the response into a web page and send it to the web server software 7 and further transmit to the web-browser 9 through the communication link net1 11 or net2 12 so that it can be displayed and viewed by a conventional web browser 9.

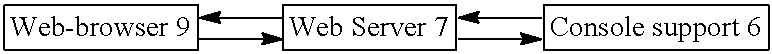

The communication protocol used between the web-browser 9 on the user's local system and the web server 7 of control system 2 could be HTTP, HTTPS, or any other suitable protocols for web communication, which could successfully transmit the data across the web. This data path may be referred to as the console support software 6 transmitting/receiving data to/from the web-browser 9 without further mention web server software 7.

The second data path is the data flow through the communication links between the control system 2 and system units 3. With this data path flow, the requests targeted to the system units 3 are passed from the console support software 6 of the control system 2 to the service modules 8 of the system unit 3 through the communication link 12. The service modules 8 of the system unit 3 will carry out the requests and if there is need, then send the response back to the console support software 6 of the control system 2. In another embodiment, the service modules 8 of the system unit 3 can provide the response back directly to the system from which the request is sent, for example, providing a streaming video back. The communication protocol used between the console support software 6 of the control system 2 and the service modules 8 of each system unit can be any suitable protocols. The typical data flow through this path could be the boot message or system status or network information or storage information of the system unit 3, and without limit.

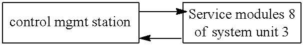

The third data path is the data flow through the communication link between the provisioned system unit 3 and the user's local system or client system 10 or host 17 or console system 1 via the communication links provided by the network infrastructure 11-12. Refer back to FIG. 1, in one embodiment, the console support software 6 of the control system 2 may present a web link or a non web-link point for an application or a file in a user interface (“UI”) on the user's local system. In another embodiment, the web link could point to an object on the provisioned system unit 3 such as a file of text, streaming video or audio, PDF, MS power point or Word documentation, and without limits. In one more embodiment, the link also could be a link to another web service program file.

From the web browser 9, the user can directly access the information on provisioned system unit 3 pointed by the web link without going through the control system 2 again via a specialized communication protocol; in one embodiment, it could use the method of download; in another embodiment, a special file transferring method of present application can also be deployed. For one example, upon a user selected a source file on a source system unit 3 and selected a destination folder on a designated system unit 3, and submitted the file transferring task, the control system 2 will transmitting the information of the task to the source and designated system for executing the task of transferring the actual file through reading and sending at source system, and receiving and writing at designated system; wherein the task information includes information of the source and designated system such as IP address and name of the system, and the path of the source file and the designated file-folder etc. Also, the transferring a file-folder can be implemented in the same way except the console support software modules 6 will first get the information for the number of files and folders under the file-folder, and then transferring one file or file-folder at a time until finishing.

In one case, the service modules 8 of the system unit 3 also includes a web server software 7 or equivalent software to support the web browser 9 direct accessing said file content without go through the control system 2 as mentioned before. Therefore, each provisioned system unit 3 provides file service or application service independent of other provisioned systems 3 and provides said service directly to the client to avoid the control system 2 to be a performance bottleneck.

In one more embodiment, a service modules 8 (a storage driver routine) of a storage system unit 3 provides reading/writing data services between the host 17 and storage system unit 3. For example in providing storage service directly to a host 17 for reading data from the storage device and sending the data out to the host 17 or receiving data from the host 17 and writing it to the storage device. In another example, reading data from a video or audio recording device and writing data to a video or audio display and playback device on the client system 10. For simplicity, the data transmitted on this path will be referred as the service software 8 that send data to or receive data from the web-browser 9 and vice versa.

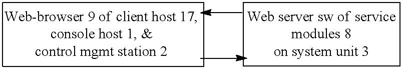

The fourth data path is the data flow through the communication links between the system units 3. With this path, in one embodiment, the service modules 8 of one system unit 3 can directly transmit data or information to the service modules 8 of another system unit 3 via a communication link provided by the network infrastructure 12 without going through the control system 2. The communication protocol between the system units 3 could be any suitable protocol. The data and information transmitted through the path 4 can be various type such as a data file without limits. For example, an user from a web-browser 9 on the user's local system may walk through a file folder on a targeted system unit 3. Later, the user instructs to transfer a file or a file-folder from the target system unit 3 to another system unit 3 by another selecting & clicking via an operation menu, therefore, the data file or a file-folder will be transferred directly between the two system units 3 without going through the control system 2.

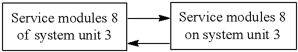

The typical CCDSVM configuration combined with the WCUWE can provide web-browser based enterprise global IT management. Furthermore, it creates a global scalable secure file server, which is a base for various web based distributed application services pools. For example, a vendor can build unlimited web-based video on-demand on top of the global scalable secure file server and other unlimited on-demand services.

FIG. 2 a) illustrates an embodiment of a variation of the CCDSVM platform, which configured only with a single control system 2 and without controlling any provisioned system unit 3. With this model, the CCDSVM is degenerated to a single standalone control system 2, on which a WCUWE can be configured such that can facilitates each user from a web-browser 9 of the user's local system and accessing the information on the Internet and performing tasks for accessing and managing the standalone control system 2.

FIG. 2 b) illustrates a variation of the CCDSVM platform in accordance with one embodiment of the present invention, This model is exact same as the typical CCSDVM as shown in FIG. 1, except there is no difference between the host 17 and the provisioned system unit 3 since each system unit 3 is also configured with a web-browser 9 and each host 17 also configured with the same service modules 8 although they may providing different services. In this model, with security permission, users who local to each provisioned system unit 3 and host 17 can login to the control management 2 from a web-browser 9 and further access & operate the resources of the control system 2, any system unit 3 and/or host 17 in the CCDSVM.

FIG. 2 c) illustrates another variation of the CCDSVM in accordance with one embodiment of the present invention. This model is the same to the typical CCDSVM as showed in FIG. 1, except that the host 17 has its own service modules 14 for providing non-web based accessing service. For example, in one embodiment, if a system unit 3 is a SAN unit providing storage volumes and the service modules 14 of the host 17 is a driver routine for reading and writing data from/to the storage volumes on the system unit 3. In another embodiment, the service module 14 is a networked software application of the client system 10 for providing a non-web browser based networked user interfaces (“UI”) for users to access the CCDSVM, and the software modules of the control system 2 and each system unit 3 communicate with service modules 14 of the client system 10 using non-web protocols. The hosts 17 may also have a web-browser 9 for the purpose of accessing the system unit 3 other than said reading data from or writing data to disk volumes.

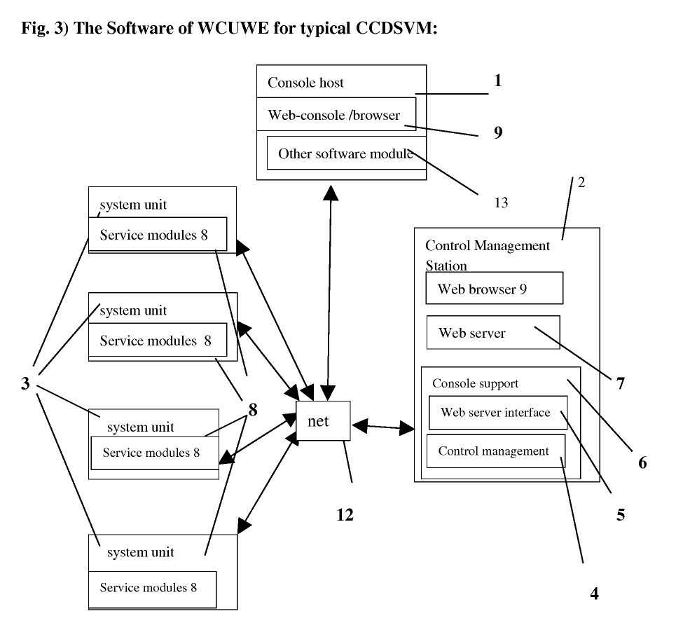

FIG. 3 illustrates the software modules of the WCUWE in accordance with one embodiment of the present invention, which can be implemented with any suitable or a combination of any suitable programming languages such C, C++, Java, JavaScript, Visual Basic, HTML, XML, etc. without limits. The software modules of the WCUWE may include software modules on the control system 2 such as web-browser 9, web server software modules 7, console support software modules 6 including web server interface modules 5, and control management software modules 4, and the software modules 8 on the provisioned system unit 3 such as service software module 8, and the software on the console system 1 such as web-browser 9, and other software modules 13.

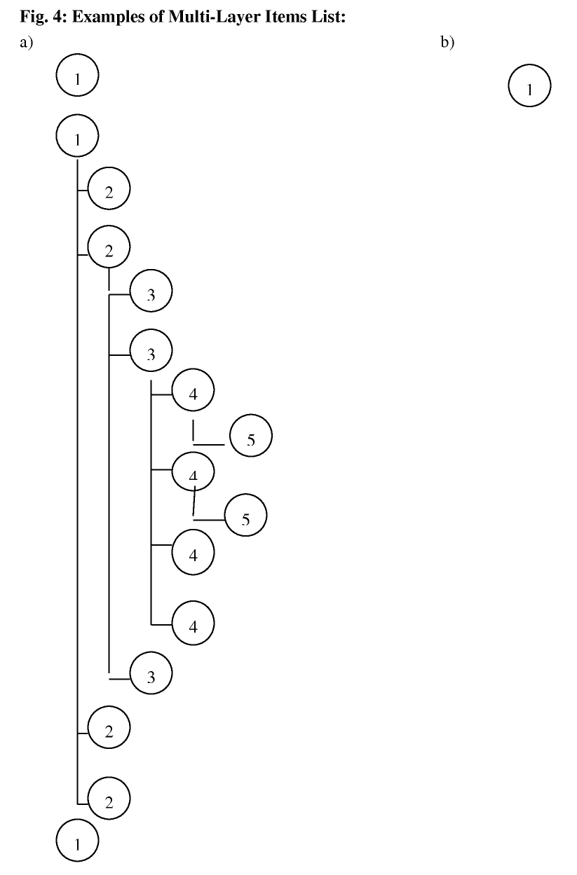

FIG. 4 a) illustrates a simplified example of a displayed multi layered item list (MLIL) which also can be called as the web folder tree in accordance with one embodiment of the present invention. This MLIL is organized with 5 layers and 18 nodes, wherein each node can associate with, and represent a particular resource of the CCDSVM. One or more nodes can be added or deleted at each layer of said MLIL depending on the nature of the operation on the corresponding said resources of the CCDSVM. If any resource node contains sub levels of resources, a corresponding selected node can be expanded to display the next level of sub resources, which will actually result in adding one or more new subsequence levels of nodes to display one or more corresponding said sub resources bellow the current node level. Also, the expanded sub-nodes can be collapsed by selecting and clicking on the expanded node, which is similar to manipulate a node of an MLIL on a MS native window based system, and the sub nodes will be dynamically deleted.

Theoretically, there is no limit on how many number of nodes and layers of the MLIL can have in the present invention, which yet basically depends on the system's total capacity. The nodes of a MLIL can be dynamically expanded or reduced depends on user's accessing and operations. In one example, if a user adds a file folder on a MLIL for a file system folder tree, or if a new system unit boot up to be added into a MLIL for a network information folder tree, a new node for the MLIL will be added accordingly. In another embodiment, if a user deletes a file in the file system via a MLIL or if a storage device being deleted from a system via a MLIL, or a system is removed from a network via a MLIL, the corresponding node on the MLIL will also be reduced accordingly along with the actual deleting or removing the actual physical resource. In another embodiment, if a user is walking through an MLIL file system tree and trying to collapse a file folder, which has one or more displayed sub file-folders or files, the MLIL will be reduced along with deleting said one or more nodes on the MLIL for corresponding said sub file-folders or files without affecting actual physical resources. In addition, one or more said MLIL can be encoded into at different locations of a web page for displaying.

FIG. 4 b) illustrates another example of the multi layered item list (MLIL) in accordance with one embodiment of the present invention. This MLIL only contains one node and 1 level and of course it can be dynamically expanded into multiple layers with multiple nodes for the specific type of resources structure.

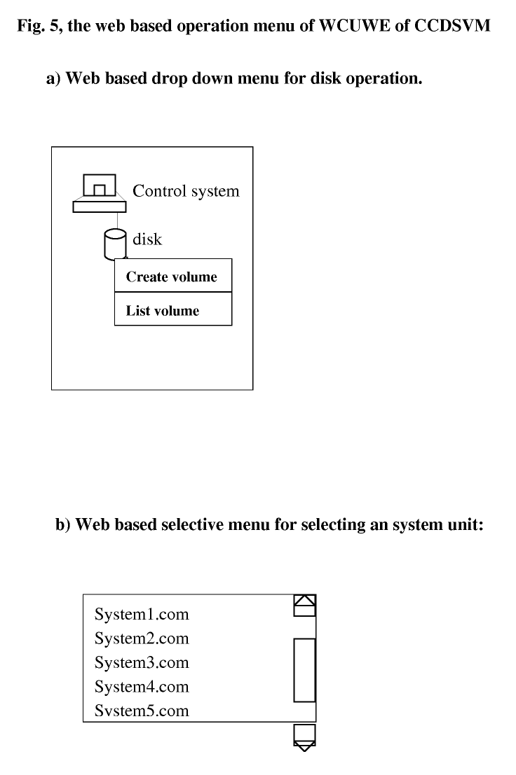

FIG. 5 a) illustrates one example of a web-based pop-up operation menu for storage volume management of a system in the CCSDVM in accordance with one embodiment of the present invention. Said pop-up operation menu is bound with each storage node on the MLIL, which is also associated to and graphically displayed through a graphic image.

FIG. 5 b) illustrates an example of a web-based selective/drop-down operation menu for selecting a system of the CCSDVM for further performing tasks on the selected system in accordance with one embodiment of the present invention.

FIG. 6 a) illustrates an embodiment of a web-based pop-up operation menu designed for storage volume management for the nodes of a MLIL which comprises a control system 2 and its two storage devices. The operating menu is associated with each storage device node on a system of the CCDSVM in accordance with one embodiment of the present invention.

FIG. 6b) illustrates an embodiment of a web-base pop-up operation menu designed for managing files and file folders, where the menu is bound to each node of an MLIL representing a file-folder and its underneath multiple files on a system of the CCDSVM in accordance with one embodiment of the present invention.

FIG. 6c) illustrates an embodiment of a web-based pop-up operation menu designed for management of the control system and 2 provisioned system units that are associated to and represented by the multi-layered nodes of an MLIL in accordance with one embodiment of the present invention.

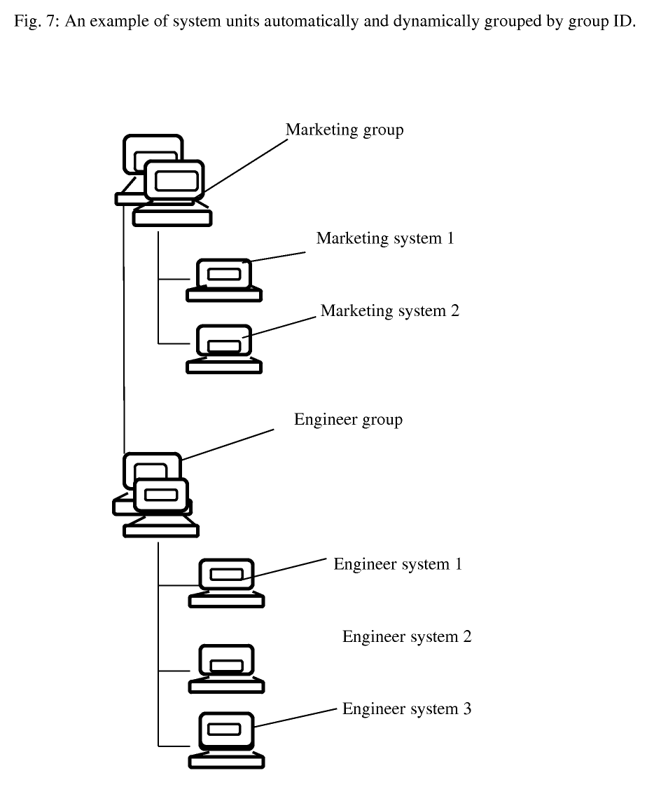

FIG. 7 illustrates an embodiment of a web-based MLIL used for representing and displaying provisioned system units in multiple groups, where each system unit is automatically & dynamically grouped based on the group ID via communicating to the control system 2. It provides one example of five provisioned system units, which are divided into two groups that are named as “marketing group” and “engineer group”. The marketing group contains 2 system units while the engineer group contains 3 system units. The groups are automatically and dynamically formed when system units boot up.

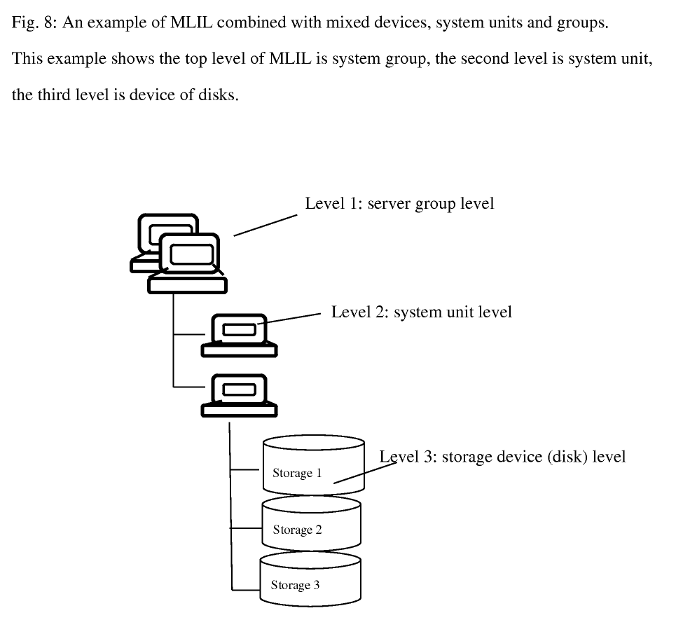

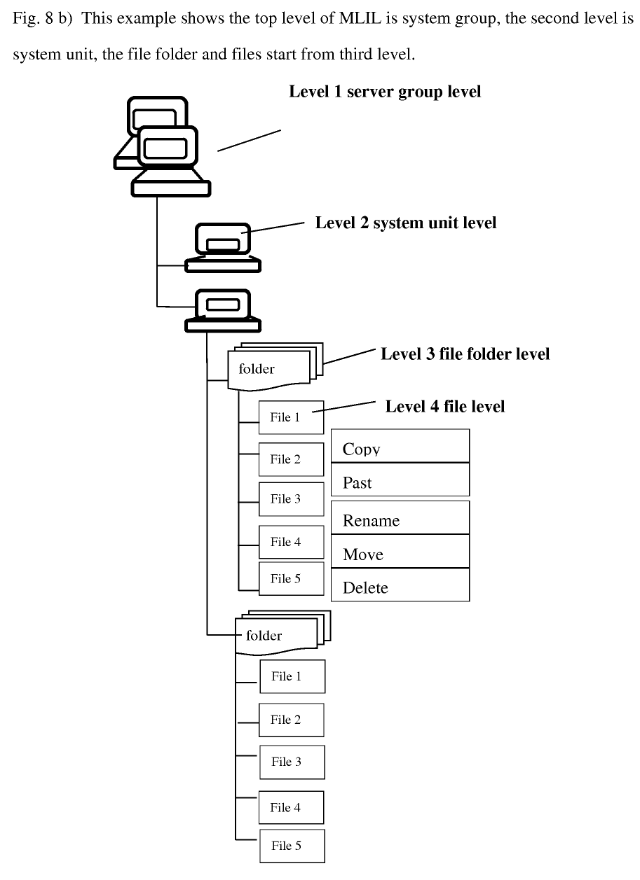

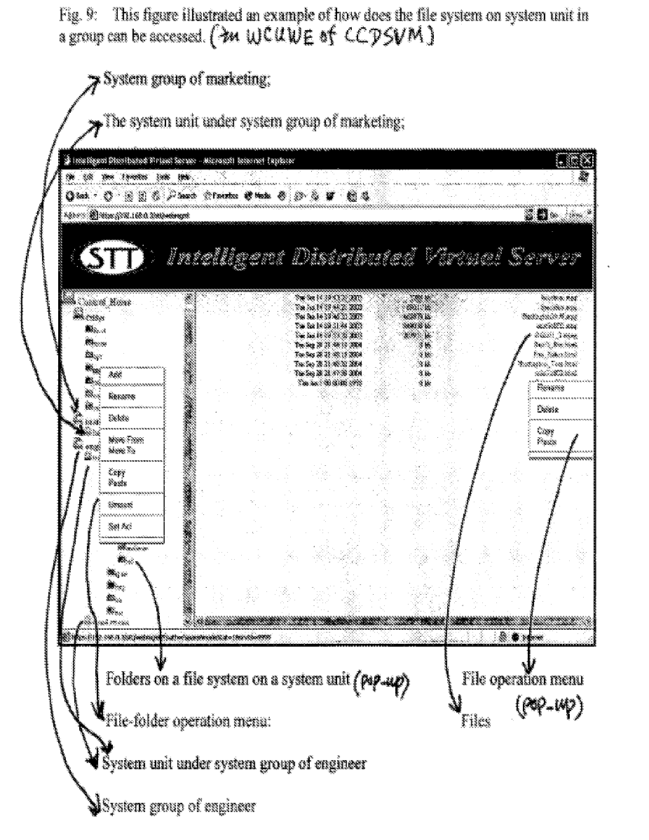

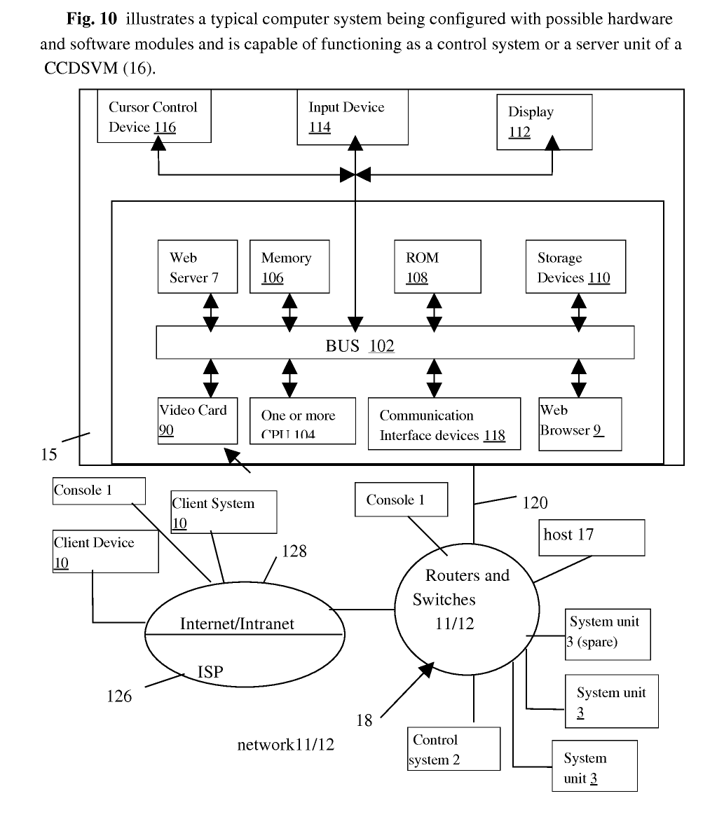

FIG. 8 a) illustrates another embodiment of a web-based MLIL used for displaying the system group, provisioned system units, and storage devices. Said MLIL has been organized with 3 layers and 6 nodes, wherein, the first level is the server/service group level (one node), the second level is the provisioned system unit level (two systems are associated with two nodes), and the third level is the system resource level (three disk storage devices are associated with three nodes in this example).

FIG. 8 b) illustrates one more embodiment of a web MLIL representing and displaying a system group, its provisioned system units 3 and files & folders on each system unit 3. Said MLIL has been organized with 4 layers and 15 nodes, wherein, the first level is the server group level (one node), the second level is the provisioned system units level (two provisioned system units are shown), the third level is the system resource of folder 3 (two folders in this case), and the fourth level is the file level (each folder contains five files). Also an pop-up folder operation menu has been brought up and is displayed.

The FIG. 1 will be used for most of the discussion of the present invention unless otherwise specified by another figure number. The FIG. 1 illustrates the web-based computer user work environment (WCUWE) of the CCDSVM provided by the software of the WCUWE FIG. 3, which includes the console support software 6 & web server software 7 on the control system 2 and the service modules 8 on the system unit 3.

The WCUWE of the CCDSVM can be initiated by the software modules of the WCUWE FIG. 3, especially by the console support software 6 of control system 2 as followings:

The console support software 6 collects and maintains one or more information lists for said major resources of the control system 2, in one embodiment they can be encoded into web pages for displaying in the web-browser 9. The resources can be collected whenever the control system 2 boots up or at other appropriate time such as upon a user request for accessing one or more corresponding resources. Actually each said resource information list is organized in the form of the MLIL. The resource information list can be stored in memory for fast retrieval and may also be stored on permanent storage such as disks.

The console support software 6 communicates to the service modules 8 of the system unit 3 for provisioning and collecting major resources information from each system unit 3 through communication links provided by network infrastructure 12. Furthermore, the console support software 6 adds the collected information of each system units 3 into a network information list (the system information list) on the control system 2. In addition, said network information list actually is organized as a MLIL, from which a mirrored MLIL can be created in memory and be encoded into web page for transmitting to and displaying in the web-browser 9. The network information list includes said resource information such as the system group, each system units 3 in a system group and its hardware and data resources etc. without limits. The network information list can be collected whenever each system units 3 boot up or a communication link to the system unit 3 is up or at any other appropriate time. For example, when a user performs a task or request to access a resource node on an MLIL that represent the network information list. The network information list can be updated in one embodiment when a system unit goes offline or a task is performed that affects a specific system in the list.

In another embodiment, the network information list can be kept directly in the memory of the control system 2 for fast access and can be organized into any suitable logical structure, such as a simple list of array, linked list, double linked list, hash table, tree structure, etc., without limit. The network information list also can be stored on permanent storage for later retrieval and for the backup purpose, and can be stored in an appropriate form, including various form of a commercial database, binary record file, and flat text ASCII file without limits. In one situation, said resource information list collected for the control system 2 and the network information list for groups of system units 3 can be combined and organized into a single MLIL for the CCDSVM and be displayed as illustrated in FIG. 9 for each user's accessing.

The console support software 6 of the control system 2 also facilitates a first privileged user to create one or more other privileged or regular user accounts that are stored into a database. The user account profile comprises information of user account name and password, user's role and credentials, security permission to access one or more resources; and in one embodiment, it also comprises a point or a link that points to a user access records file, which recording the accessing information that performed by the user from time to time. The recorded information includes a user at what time, from where (a specific IP address, and/or Mac address of a computing system), performed what tasks, and accessed what the resources.

Actually, the console support software modules 6 receives and parses each user's accessing request, and writes information of each user's request into a access record in the per user secure access file. In another embodiment, the per user secure access record file can be backup by copying it to another file with a special name tag, and in one more embodiment it can further be emptied on a periodic bases for keeping the up to date user's access records. Said first privileged user is created during installing the console support software 6 on the control system 2.

In one embodiment of supporting a privileged user from a web browser to create a new user, the console support software 6 of the control system 2 facilitate web pages including one or more input areas for specifying an address information from where the new user is permitted to access the CCDSVM, in one case from a system with a specific MAC address or an IP address; specifying and assigning a specific sized storage volume for the user's exclusive accessing; specifying one or more targeted systems in one or more targeted service groups (system groups) for permitting the designated user accessing; specifying each user's role such as super user or system user or general user, specifying the specific tasks can be performed by a user with specific role such as configuring system or monitoring system or creating authentication for user or transfer file between the systems of the CCDSVM or shutdown the CCDSVM; and specifying what type of application program files or data files the user can access etc without limits. Actually, each user's security credentials, access permissions, and authentication information are encoded into each corresponding field in a security data structure and to be stored in the database by the console support software 6.

In another one embodiment, the console support software 6 of the control system 2 facilitates a centralized user security authentication management mechanism. It includes facilitating privileged users from web browser to perform user administration tasks including creating new privileged or non-privileged user account, displaying the current permission and authentication for a specific user, deleting a user account, modifying and updating the password, permission and credential for a specific user including each system group that a user is permitted to access or manage, and one or more system units in a system group that is permitted for accessing.

Users from a web-browser on a client system 10 or host 17 or console system 1, or control system 2 or system unit 3 can login to the CCSDVM via a login web-page provided by the console support software 6 of said control system 2. After the login, the console support software 6 of the control system 2 graphically or textually displays one or more resources information including accessible one or more hardware devices, service programs or data information into each user's web browser based on each user's security credential and permission. Therefore, each users from his/her own web-browser 9 can interactively perform tasks of accessing one or more permitted resources information on the control system 2 and (or) on each system unit 3 or host 17.

The tasks, which can be performed from said web browser, are compatible to tasks that can be run on either native window based or command-line based computer user work environment as discussed in said prior applications of Ser. Nos. 10/713,904 and 10/713,905.

In order to provide convenience for each login user to perform tasks in the WCUWE, the console support software 6 is capable of displaying a multi-layered item list (MLIL), as shown in FIG. 4, together with associated web-based operation menu (FIG. 5) in response to the user interacting to a related resource information for accessing and managing the actual multi-level organized resources of the CCDSVM. The resources as mentioned before could be the files or file folders of a file system, a list of provisioned system units 3 on the network, or the users and their security profile etc. without limits. In one embodiment, the console support software 6 maintains a user space task list for supporting each user interactively submitting requests, where the user space task list is protected by a lock for storing each task information. If there is a need to display a web based structured multi-layered item list (MLIL) 4 for resources on the target systems of the CCDSVM in response to a user interactively accessing a displayed resource that related to the MLIL, the console support software 6 of control system 2 will perform the following actions:

a) For each user sessions, a memory management module of the console support software modules 6 creates a mirrored MLIL with one or more nodes in response to the user accessing a corresponding resource that related to a MLIL, wherein each node of the mirrored MLIL can be flexibly expanded or reduced or collapsed in response to the user's instant accessing and operating for each corresponding physical resource via the displayed MLIL. For example, via the displayed MLIL the user can expand a node of a MLIL by selecting and clicking on the node as long as it has a next level of one or more resources; the user can collapse a previously expanded node of a MLIL by selecting and clicking on said node again. A new node for a MLIL can be added or an existing node of a MLIL can be deleted in response to said user to perform corresponding tasks via said operation menu. Further, the console support software 6 creates an association between each created mirrored MLIL and the actual targeted physical resources. The created mirrored MLIL can reside in memory in a form of a list structure such as a simple array list, link list, double link list, various tree structure, or hashed table, etc. without limits. Since the memory management module is a part of the console support software modules 6, in most cases for the convenience of discussion, only the console support software modules 6 will be mentioned instead of mentioning memory management module.

b) For each created mirrored MLIL, in one embodiment binding an appropriate corresponding graphic image and/or text description to each node (item) on the MLIL for the purpose of visual displaying; and selectively binding each node (items) of the MLIL with a corresponding resource's appropriate attributes. In another embodiment, the attributes of a resource include the name, ID, size, type, timestamp, ownership (access permission), location, and other information of a physical resource object. The attributes also reflect the nature of the actual resources such as level of a resource without limits, therefore, the resources can be encoded into the web page and correctly displayed through the MLIL.

c) in one more embodiment, for each created mirrored MLIL, binding operation menu to each node of the MLIL. The operation menu can be either a web-based pop-up menu or a drop-down selective menu that illustrated in FIG. 5, or can be one or more submit buttons. Each operation menu comprises one or more operating options, wherein each operating option is associated with a specific task for operating the corresponding resource.

d) Convert each created mirrored MLIL and all associated information of the MLIL, (such as graphic or text presentation, operating menu, attributes of said resource etc. without limits,) into said standard structured format for web communication, which means to encode said information of the mirrored MLIL into a web page for being displayed in the web-browser 9. The converted information of the MLIL in a web page will be transmitted from the console support software 6 of the control system 2 to each users' web-browser 9 on the user's local system. Therefore, the physical resources of the CCDSVM and all associated information can be interactively viewed and operated by all users from each of their web-browser 9 via each user's MLIL. The encoded logical item list in the web page can be transmitted using web protocol such as HTTP, HTTPS or any other suitable protocol without limits.

e) After each user interactively selecting information via a web displayed MLIL and submitting a task for viewing, accessing or operating said resources of the CCDSVM, the console support software 6 of the control system 2 receives, parses and, in one embodiment, performing following major steps for each parsed task: (1) obtains the lock that protecting the user space task list; stores the task information into an available slot of the user space task list; then release the lock; (2) run the task into background and distribute the task to be executed on one or more targeted systems; (3) providing a response including the task status back to the corresponding user's web browser without waiting the completion of the task; (4) cleanup the task information in the corresponding slot of the user space task list in response to the completion of the task. Further, the console support software 6 may update the information of each MLIL in memory and update the corresponding web-page encoded with MLIL in a web browser based on the status or the results of the task execution.

In one embodiment, the step (3) further includes the console support software 6 of the control system 2 obtains the task status or result from the control system itself if the control system itself is a targeted system; and from each targeted system unit across the network infrastructure 11/12 if the system unit is a targeted system. Most importantly, the user at web browser 9 can check the task status at any time regardless the task is finished or not, and can continuously interact and perform other tasks since the web browser screen will never be blocked or freeze. Said task status can include a failed status if the task executing or validation failed, a status that indicates a task is in progress, or a result status if the task is success and if there is need, where said result status can be a point to a location that the final or actual result will be deposited or the actual result itself. Actually, the above steps for task execution are applicable for all tasks submitted from web browser or from non-web networked UI.

Also, said memory management module of the console support software 6 keeps tracks of memory usage and status for each correspondent MLIL, which may be expanded or collapsed along with said tasks being executed over said resources. For one example, a task of deleting a file or folder requires the deletion of the actual file or folder on a designated system and deleting the corresponding one or more nodes and associated information on the mirrored MLIL in the memory and in the MLIL itself. For another example, a task for adding one or more file-folders/directories will require to add one or more nodes into the mirrored MLIL and the MLIL itself as well as adding the actual physical one or more file-folders into a file system. In one more embodiment, the operation of listing next level of one or more sub-node for a node, will add one or more nodes into the mirrored MLIL without affecting physical resources. In another example, the operation of collapsing a previously expanded node will deleting one or more nodes in the mirrored MLIL yet without affect the original MLIL and the actual physical resources. The console support software modules 6 will update the web page in web browser to reflect the updated information of said mirrored MLIL.

More importantly, all processes or threads of a user session created by the console support software 6 to perform tasks of operating resources represented by the MLIL can effectively share the dynamically modified mirrored MLIL with a consistent view throughout the users' entire access session. This requires said memory management module of the console support software 6 to dynamically translate and map the initial memory address of a mirrored MLIL of a user session to another logical memory address in each process/thread of the user session during the user's interaction in performing task, therefore, the different processes or threads of the same user session can effectively access and share the same physical memory object of a dynamically modified and updated MLIL during the user session.

In addition, one or more locks may be deployed for protecting other resources associated with executing each task in addition to a lock used for protecting a user space task list disclosed previously. Using lock to protecting resource shall be regarded as default action for task execution in present invention and will not further be mentioned in details. The steps described from b) to e) above can be repeatedly processed as long as user keep interacting and working on resources represented by a same specific MLIL. The steps a) to e) also can be repeated for user access each resource represented by a different MLIL.

f) For each user who voluntary or non-voluntary ending his/her access session such as logged-out from the CCDSVM, each created MLIL of the user session will be deleted by the memory management module of the console support software modules 6. In one embodiment, if a user stops accessing resources related to a current MLIL and starts accessing resources on another MLIL, the mirrored MLIL of the current MLIL may be deleted depends on the needs of the application.

The accessing and managing file system has always been an important part of any computer user work environment (CUWE) in the past. Supporting a file system to be accessed by users from a network has always been a challenge to many vendors. As disclosed before that users can perform tasks such as managing storage volume pool of the entire CCDSVM from a web browser 9, and creating, managing, and accessing the file system on the storage volume of either control system 2 or each system unit 3. Also in one embodiment, one or more file systems on the control system 2 or system unit 3 can be built on storage volumes on one or more IP SAN or non-IP SAN units such as fiber channel SAN unit in addition to built on its local storage devices. As matter of the fact in one case, the CCDSVM can provides a virtual file server pool including a plurality of file systems on a plurality of system units 2 or hosts 17 that in one embodiment may utilize storage volumes on a plurality of SAN units in a storage volume pool within the same CCDSVM.

In addition, users can perform all file and folder management tasks such as add new folder, or delete and rename file or file folder, copy/paste and move file or file folder without size limit either between locations on a same target system or cross one or more systems. The combination of the MLIL and operation menu of the web based new UI is particularly suitable for said managing and accessing file systems of the CCDSVM. Actually users can more efficiently and instantly accessing and managing files and folders, and file systems on systems of the CCDSVM from web-browser 9 without caching any file or file system.

The new web UI is capable of including the multi-layered item lists (MLIL) for representing the actual file & folder structure of the file systems on each target system of the CCDSVM, where each node of the MLIL may represent a file-folder or a file system or a file. When a user from a web-browser 9 walks through the displayed file system on the MLIL by selecting and clicking to view or access each file, file-folder or file-system including operating via operation menu, only a small piece of information, which relates to the file or folder or file-system being operated on, needs to be retrieved or transmitted between a target system of the CCDSVM and the console support software 6 of the control system 2.

For one example, if a user wants to add or delete a node such as a file folder node on a MLIL, the only major information needed to be transmitted from the control system 2 to the target system is the folder name, and the target system shall carry out the task and provide a response. Also, said console support software 6 of the control system 2 will update said MLIL in the memory and update the web page that encoded with the MLIL in the web browser after the task is executed.

For another example, if a user wants to access an information/resource which is bellow the current node on the MLIL, such as the files and sub folders bellow a current file folder, the only information need to retrieve from a target system is the attributes of the sub-folders and files if there is any under the current folder. The attributes of a file or file-folder are the name, size, type, timestamps, ownership and security permission for read, or write, or both read and write, and the location of a file such as located on which system and its path etc.

In one embodiment if a privileged user wants to set access control for a file or a file-folder on any target system of the CCDSVM via the displayed MLIL for permitting one or multiple designated users either inside a corporation or from a partner corporation to access, the information of said target system and the information of the file or folder need to be added into and bound with each of designated user's account profile. For example, the console support software 6 facilitates privileged user browsing and selecting a targeted file or file-folder via the web MLIL, then setup said permission for a designated user via an operation menu which having an operating option of set access control together with the inputted designated user's information. In another embodiment, the same scenario can be applied for users on the social network for sharing files and folders and other information via set access control.

On the other hand, if said privileged user wants to revoke a previously granted permission for a targeted user, the privileged user can delete permitted information from the targeted user's account profile in the user database via the displayed targeted user's account profiles. The target systems could be either control system 2 or system unit 3 of CCDSVM. The present invention has created a method of displaying one or more file systems on one or multiple systems without caching any actual files, file folders, and file systems. Meanwhile, the web page displaying said MLIL can be updated quickly in real-time in web browser in response to the users interactively performed tasks of accessing and managing file system, and its files and file-folders.

The different types of files can be organized and displayed differently via the MLIL based on the usage of the file in response to the user send or receiving messages. In one embodiment, a tope level of a message record file can have second level nodes of sent, received, deleted, drafted, and/or according to the nature of the message such as news, business, health, sports, etc., and each individual message nodes can be listed at third level etc. without limits. In another embodiment, at tope level of user secure access records file can have the second level nodes according to departments' or projects' requirements, and each individual user's access records can be organized at third level, and each individual accessing records of each individual user can be organized at 4^{th} level, and so forth without the limits.

In one embodiment, if users need to view or edit the content of a file on a system unit 3, the file may be transmitted via a communication link 11-12 directly from the target system unit 3 to the web browser on the user's local system. If the file is on control system 2 and users like to view or edit it from a remote system, the file is transmitted via the communication link 11-12 from the control system 2 to a web browser 9 on the user's local system. Also, the file is required to be converted from the original format to another format, which may be viewable and editable in said web-browser 9.

With a proper viewing tool on the user's local system, which may be invoked from the web-browser 9, the user is able to view the contents of the file. With a proper editor, a user can further edit the file and then transmit the file back to the target system of either the system unit 3 or the control system 2.

In one embodiment, the file may also be transmitted from the target system to the control system 2 and then be converted from the original format to another format that is viewable and editable in said web-browser 9. After conversion, said file may be transmitted from said control system 2 to a web browser on the client system 10 or console system 1 or control system 2 for viewing or editing within the web-browser 9. If the target system is the control system 2, there is no such transmission required.

Network information also is an important part of the WCUWE of the CCDSVM. As matter of the facts, each system unit 3 and/or host 17 of the CCDSVM of the present invention can be automatically and dynamically provisioned into one or multiple service groups based on the system's group ID and type, system name and IP address across LAN/WAN, Intranet and Internet, where each group contains at least one provisioned system unit 3 or host 17 for providing a dedicated services.

To effectively access and manage the automatically grouped system units 3 and their associated hardware and data resources, the multi-layered item list (MLIL) also can be used. In one embodiment, the mixed information of the CCDSVM can be ordered with top-down fashion, wherein each server-group and/or each top control system at the top level, system units 3 at second level, and hardware devices or file system starting from the third level on said MLIL, and so forth without limits. Other embodiments for the top-down layout order of a MLIL for a CCDSVM are also possible and really depends on operation's requirement, therefore, there is no limitation.

More specifically, each node on a MLIL with a different level or type may associate with a different type of operation menu. For one example, a node of a provisioned system unit 3 on a MLIL may associate with an operation menu containing operating options of system status, shutdown, storage management, change system usage such as changing service etc without limits; For another example, a node of storage device may associate with an operation menu with options of creating storage volume, displaying storage volume, deleting storage volume, combining storage volumes or splitting storage volume; and for third example, a node of file or file folder may associate with an operation menu containing options of add, rename, delete, copy/paste, move etc. so forth without limits. In addition, one or more backup and restore operations also can be performed easily via menu options and without blocking the web browser screen and without taxing the data network within the network topology layout of present application, wherein a file transferring mechanism of present invention can be used for networked backup and restore. After submitting each said operation via said menu, the corresponding web page will be updated correspondingly independent of the final result, said responding web page may encoded with either a status of operation such as fail or in progress or success, or a location (address) that the result to be deposited or an actual result itself.

After said conversion of all information associated with the MLIL to the standard structured format for web (that is to encode said information of MLIL into web page), the complex information on the network can be viewed and operated much more easily from a web-browser 9 via the selecting and clicking mechanism. For example, FIG. 7 shows the system units 3 are provisioned into multiple groups. FIG. 8 shows the example of how a device such as storage is listed under system units 3 in each service group can be accessed and managed. FIG. 9 illustrates how the file systems on system units 3 in multiple service pools (groups) can be accessed.

With the method of automatically and dynamically grouping system units 3 and wisely use the MLIL to represent the diversified resources on network, the entire CCDSVM can be much more efficiently accessed, operated, and managed via a single MLIL as illustrated in FIG. 9, specially people can perform streamline operations. In one example, by simply selecting and clicking on a storage node of a targeted system on the MLIL displayed in a web-browser 9, a privileged user can create one or more storage volumes from a fresh disk drives on the target system, then create file system on the created storage volume, and mount the created file system, next to create folder structures on the top of the mounted file system and move or copy data file or file-folder from other location into the created folder structure and further setup access control for designated users to accessing the permitted files and file folders with limited privileges.

In one embodiment, a system administrator may manually assign a specific sized storage volume on a SAN or on a NAS system unit 3 in a storage pool to be exclusively accessed by a host 17 in a service pool via the MLIL; So that the host 17 obtains a map information from the control system 2 for accessing the requested storage volume on an assigned system unit 3 in a storage pool, and the system unit 3 also obtains the same map information regarding which specific sized storage volume is assigned to which host 17 for exclusive accessing; therefore, the host 17 can securely and directly access the assigned storage volume on the system unit 3 without going through the control system 2 after an authentication negotiation process. In addition, said mapping can be synchronized between the control system 2, system unit 3 and host 17.

Following similar steps of set access control for file or file-folder, the privileged user can easily setup access control for each system group, each system unit, and each resources for permitting one or more designated users accessing said system group, and said system unit. In one example, a privileged user can browse to a system group node and perform task of setup access permission control for granting designated users to access all resources of the selected system group, in one embodiment performed via an “set ACL” option associated to an operation menu as illustrated in FIG. 9. The user also can browse to a system node and perform task of setup access permission control for granting designated users to access all resources of the selected system via an associated operation menu; In addition, a user can browse to a specific file-folder node of a specific file system on a specific system and perform task of setup access permission control for granting targeted users to access one or more files and sub folders under said file-folder; or can browse to a specific device node such as a network cards or a storage device and perform task of setup access permission for granting designated users to manage such devices, and so forth without limit.

Said granted and permitted resource information will be bound to targeted user's account profile and to be validated upon user login to the CCDSVM and performing task against the assigned and permitted resources of the CCDSVM. The granted security permission also can be revoked with the same steps as granting security permission for accessing except via different operating option of the operation menu. In another embodiment, the granted security permission can simply be removed from the user's security profile directly. Therefore, the WCUWE can permit designated users securely access only permitted resources on a global network from a web-browser 9 on a user's local system anywhere around the world.

Initially, said WCUWE allows a default super user to login to the WCUWE of the CCDSVM, which actually is login the control system 2, and is capable of accessing the authentication web-page provided by said console support software 6. Therefore, the privileged super user can setup other privileged or non-privileged users' account and their profile thereafter. Similar to file system in the WCUWE of the CCDSVM, the users' account and profile also can alternatively be viewed and operated on using a MLIL. Combined with a web-based operation menu such as illustrated in FIG. 5, users' account profiles can be further converted to said standard structured information (encoded into a web page), which can be viewed and accessed by each privileged user from the web-browser 9.

Therefore, through selecting and clicking a user profile node on the MLIL and using web-based operation menu, a privileged user can conveniently perform all compatible tasks that normally require more steps to perform for user authentication management. Said tasks include creating the user account and profile, viewing, updating, or deleting user account profile and other operations without limits. Specially, the privileged users can setup profiles for other non-privileged users for secure access control. In addition, the user information and their security profile can be kept in any form of a database, which could be a commercial database on the market, or a plaint text file, or a binary record file, or others without limits.

Having many discussing for the web based MLIL to be used in web based computer user work environment (“WCUWE”), nevertheless, the web browser is only a network application, therefore, the MLIL can actually be used in any networked application to provide an efficient networked user interface for a networked server by deploying other specialized communication protocols including specialized TCP/IP/UDP protocols other than web protocols such as HTTP or HTTPS. Specially, it can be used by a non-web based networked computer user work environment.

Also, in one embodiment, the service software modules 8 of the system unit 3 can include equivalent functionality of the console support software 6 of the control system 2 for support MLIL. Therefore, each system unit is capable to provide its own web based user work environment including the support for the MLIL in response to each user's access and manage the system unit 3 from the user's web browser 9 either via login the control system 2 or via locally login the system unit 3. In addition, in one embodiment a system unit 3 can also be called as middle level control system that can access, monitor and manage another layered one or more system units 3 in a multi-layered larger layered CCDSVM environment as depicted in FIG. 11.

With the layered CCDSVM infrastructure illustrated in FIG. 11, the middle level system unit is also the middle layer of a control system node which keeps an individual system information list for its next level system units 3 immediately bellow it. Similar to the non-multi-layered CCDSVM, the system information list can be collected by the top or middle level control system node at the boot time of each system unit and further to form a group. The CCDSVM can have at least one top control system, and in one embodiment each top control system can control a management pool of a plurality of middle level control systems, and each middle second level control system in the management pool can control a service pool of a plurality of system units 3 as illustrated in FIG. 11. In another example, a top control system can control a service pool comprises a mixed number of middle control systems, and system units or hosts; and each middle control system also can control a service pool having a mixed number of mentioned systems.

In one embodiment, a top layer control system is a spare one and it is activated for replacing a fault top level control system for continuing controlling the management pool. For example, as illustrated in the FIG. 11 the “top spare” can replace the “top” control system for continue controlling a management pool of level 2 middle level control systems in an event of the “top” control system having fault. In another embodiment, a spare middle level control system is activated for replacing a fault middle level control system in the management pool for continuing controlling a service pool of a plurality of system units whenever the fault is detected by the top level control system, for example, a “middle spare” will replace the “middle N” for continue operation.

In third embodiment, a spare system unit is activated for replacing a fault system unit in a service pool whenever the fault is detected by a corresponding middle level control system. For example, a middle level control system labeled with ““middle N” has detected one of system unit having fault, and instructing a spare system unit to replace the faulted system unit for continue providing service to the clients. In addition, each system unit in a group can be dynamically added or removed without effecting the normal operation of the CCDSVM. In addition, each service group (pool) at each level of the multi-layered CCDSVM can be flexibly provisioned across a corporate Intranet, Internet, LAN, or WAN, in one embodiment across a corporate storage network.

In one example, each user's authentication and privilege scope can include assigning to access a specific group of systems at a specific level only or assigning to access systems in one or more groups. If a user assigned to access a top level control system, the user may have privilege of accessing entire CCDSVM or accessing one or more middle level control systems and one or more system units in each service pool that controlled by a corresponding permitted middle level control system.

In another example, if a user is not permitted to access the top level control system yet permitted to access a specific middle level control system, the user is only can be permitted to access one or more systems in a service pool controlled by that middle level control system. This will greatly enhance the integrity and security of a larger infrastructure of a CCDSVM. As matter of the fact, each middle level control system can also provide one or more users a central access point to access one or more system units bellow the middle level control system.

In one more embodiment, the entire multi-layered CCDSVM can be similarly managed via a single web folder tree (MLIL), and having similar advantages for security management, web multi-tasking support, system, network and storage accessing and management. Also the control system at each level capable of providing centralized control for accessing to the systems bellow its level and capable for distributing tasks and various requests to the identified systems under its control. Also each system unit controlled by a control system at each level is capable of providing services to requested system independent of the control system and other system unit at same group.

Much have being discussed, now let us discuss more on the typical computer systems in present invention is depicted in the example of FIG. 10, the distribution control station (2) comprises a computer system (15) which includes a bus (102) or other communication mechanism for communicating information, and a processor (CPU) (104) coupled with the bus (102) for processing information. The computer system (15) also includes a main memory (106), such as a random access memory (RAM) or other dynamic storage device, coupled to the bus (102) for storing information and program instructions to be executed by the processor (104). The main memory (106) also may be used for storing temporary variables or other intermediate information during execution or instructions to be executed by the processor (104).

The computer system (15) further includes a read only memory (ROM) (108) or other static storage device coupled to the bus (102) for storing static information and instructions for the processor (104). a storage device (110), such as a magnetic disk or optical disk, is provided and coupled to the bus (102) for storing information and instructions. The bus (102) may contain, for example, thirty-two address lines for addressing video memory or main memory (106). The bus (102) can also include, for example, a 32-bit data bus for transferring data between and among the components, such as the CPU 104, the main memory 106, video memory and the storage media (110). Alternatively, multiplex data/address lines may be used instead of separate data and address lines.

In one embodiment, the CPU (104) comprises a microprocessor manufactured by Motorola(R), such as the 680x0 processor or a microprocessor manufactured by Intel(R), such as the 80X86, or Pentium(R) processor, or a SPARC(R) microprocessor from Sun Microsystems(R). However, any other suitable microprocessor or microcomputer may be utilized. The main memory (106) can comprise dynamic random access memory (DRAM). And video memory (not shown) can comprise a dual-ported video random access memory.

The computer system (15) may be coupled via the bus (102) to a display (112), such as a cathode ray tube (CRT), for displaying information to a computer user. An input device (114), including alphanumeric and other keys, is coupled to the bus (102) for communicating information and command selections to the processor (104). Another type of user input device comprises cursor control (116), such as a mousse, a trackball, or cursor direction keys for communicating direction information and command selections to the processor 104 and for controlling cursor movement on the display (112). This input device typically has two degrees of freedom in two axes, a first axis (e.g., x) and a second axis (e.g., y) that allows the device to specify positions in a plane.

According to one embodiment of the invention, the steps of the processes encoded in the hardware and software modules of the present invention is provided by computer systems (15) in response to the processor (104) executing one or more sequences of one or more instructions contained in the main memory (106). Such instructions may be read into the main memory (106) from another computer-readable medium, such as the storage device (110). Execution of the sequences of instructions contained in the main memory (106) causes the processor (104) to perform the process steps described herein. One or more processors in a multi-processing arrangement may also be employed to execute the sequences of instructions contained in the main memory (106). In alternative embodiments, hard-wired circuitry such as Application Specific Integrated Circuit (ASIC) may be used in place of or in combination with software instructions provided by the software modules of present invention to implement the invention. Thus, embodiments of the invention can be any combination of hardware circuitry and software modules.

The term “computer-readable medium” as used herein refers to any medium that participated in providing instructions to the processor 104 for execution. Such a medium may take may forms, including but not limited to, non-volatile media, volatile media, and transmission media. Non-volatile media includes, for example, optical or magnetic disks, such as the storage device (110). Volatile media includes dynamic memory, such as the main memory (106). Transmission media includes coaxial cables, copper wire and fiber optics, including the wires that comprise the bus (102). Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions, which encoded in various software modules, to the processor (104) for execution. For example, the instructions may initially be carried on a magnetic disk of a remote computer. The remote computer can load the instructions into its dynamic memory and send the instructions over a telephone line using a modem. A modem local to the computer system (15) can receive the data on the telephone line and use an infrared transmitter to convert the data to an infrared signal. An infrared detector coupled to the bus (102) can receive the data carried in the infrared signal and place the data on the bus (102). The bus (102) carries the data to the main memory (106), from which the processor (104) retrieves and executes the instructions. The instructions received from the main memory (106) may optionally be stored on the storage device (110) either before or after execution by the processor (104).

The computer system (15) also includes a communication interface (118) coupled to bus the (102). The communication interface (118) provides a two-way data communication coupling to a network link (120) of the net1 or net2 (11) that is connected to routers in net1 or net2 (11). For example, the communication interface (118) may be an integrated services digital network (ISDN) card or a modern to provide a data communication connection to a corresponding type of telephone line, which can comprise part of the network link (120). As another example, the communication interface (118) may be a local area network (LAN) card to provide a data communication connection to a compatible LAN. Wireless links may also be implemented. In any such implementation, the communication interface (118) sends and receives electrical electromagnetic or optical signals that carry digital data streams representing various types of information.

The network link (120) typically provides data communication through one or more networks to other data devices. For example, the network link (120) may provide a connection through a local network to a host/server computer or to data equipment operated by an Internet Service Provider (ISP) (126) via switched of net1 or net2 (11). The ISP (126) in turn provides data communication services through the world wide packet data communication network now commonly referred to as the “Internet” (128). The Internet (128) uses electrical electromagnetic or optical signals that carry digital data streams. The computer system (15) further includes web server (7) for providing e.g. a user interface to the clients (10) for requesting data streams from the virtual server (16). In one example said user interface can include a list of available video content files in the virtual video server (16) and ways of selecting content files for viewing, including optionally payment terms.

The computer system (15) can send messages and receive data, including program code, through the communication interface (118). In the Internet example, clients (10) can transmit code (e.g., program instructions, HTML, etc.) for an application program through the Internet (128), the ISP (126), and communication interface (118).

The example versions of the invention described herein can be implemented as logical operations in a distribution control station (2). The logical operations of the present invention can be implemented as a sequence of steps executing on distribution control station (2). The implementation is a matter of choice and can depend on performance of the distribution control station (2) implementing the invention. As such, the logical operations constituting said example versions of the invention are referred to for e.g. as operations, steps or modules.

The present invention has been described in considerable details with references to prior applications from the same inventor and preference to certain preferred versions, examples, and figures; however, other versions, and samples are also possible. Therefore, the spirit and scope of the appended claims should not be limited to the description of the preferred versions and samples contained herein.

What is claimed is:

1: A method of using web folder tree to manage and access a multi-layered virtual server, in which the virtual server comprises:
at least a top control system controlling a management pool of a plurality of middle control systems across a network infrastructure,
at least a middle control system in the management pool controlling a service pool of a plurality of system units across the network infrastructure, and
at least a system unit in a service pool being configured providing services to a plurality of client systems;
the method implemented in each control system at each level comprises the acts of:
A) constructing a multi-layered item list (“MLIL”) for representing the control system and a plurality of system units which controlled by the control system across the network infrastructure, and
B) performing following acts in response to each user accessing one or more resources related to said MLIL:
C) creating a mirrored MLIL with one or more nodes in the memory of the control system for reflecting the MLIL and for easy manipulating;
D) encoding and including the mirrored MLIL in a web UI via web page to be transmitted and displayed into the user's web browser in response to the user accessing the virtual server from the user's local system;
E) updating the mirrored MLIL in the memory and in the user's web browser through corresponding updated web UI in response to the user via the displayed MLIL interactively performing one or more tasks of accessing or managing the resources of the virtual server during the user's entire access session.

2. The method of claim 1, wherein the
act a) further comprises: constructing a MLIL on a top control system for the multi-layered virtual server which includes at least a node to represent the top control system itself.
act c) further comprises act: binding each node of the multi-layered virtual server MLIL with a specific graphic image, an specific operation menu and attributes for a specific type of resource that the node is represented for;
act d) further comprises act: displaying at least a node representing a top level control system on the MLIL in response to the requirement for the user accessing the resources of the multi-layered virtual server from the top control system down to the lower levels;
act e) further comprises act: facilitating the user capable of via the MLIL in web UI accessing at least a top control system first and further via the top control system node to access next level one or more systems of the virtual server, and capable of recursively via a middle control system in a non-lowest-level service pool to access next level one or more systems in another service pool.

3. The method of claim 1, wherein the
act a) further comprises: constructing a MLIL on a middle control system for a service pool which includes at least a node represent middle control system itself.
act c) further comprises act: binding each node of the service pool MLIL with a specific graphic image, an specific operation menu and attributes for a specific type of resource which the node is represented for;
act d) further comprises act: displaying at least a node representing the middle control system on the MLIL in response to the requirement for the user accessing the resources of the service pool from the middle control system down to the lower level;
act e) further comprises act: facilitating the user capable of via the service pool MLIL in web UI accessing at least the middle control system first, and further via the middle control system node to access next level one or more systems of the service pool, and capable of recursively via a middle control system in a non-lowest-level service pool to access next level one or more systems in another service pool.

4. The method of claim 1, wherein the act e) further comprises:
act f) linking same type of resource nodes of a mirrored MLIL with same type of operation menu and different type of resource nodes of a mirrored MLIL with different type of operation menu in response to resource operating requirement;
act g) expanding a mirrored MLIL in memory by adding one or more nodes to represent one or more physical resources at a designated level of the MLIL, and displaying the updated MLIL in the user's web browser to include the expanded one or more nodes via an updated web UI in response to the user's interacting that requires expanding the mirrored MLIL;
act h) reducing a mirrored MLIL in memory by deleting one or more nodes at one or more designated levels of the MLIL, and displaying the updated MLIL in the user's web browser that not includes the deleted nodes via an updated web UI in response to the user's interacting that requires reducing the mirrored MLIL;
act i) for each mirrored MLIL, tracking the memory usage and the status, and translating logical memory address of a mirrored MLIL for each process/thread created during a user session, therefore, each process/thread of said user session capable of consistently accessing the same instantly updated mirrored MLIL object in memory in response to the user's each interaction and requested task; and
act j) deleting a mirrored MLIL in memory in response to a corresponding user exiting from current user session.

5. The method of claim 4, wherein said act j) further comprises:
deleting a mirrored MLIL in memory in response to the user starting accessing a resource that associated to another MLIL with a new created mirrored MLIL.

6. The method of claim 1, wherein said act e) further comprises:
a method implemented in each control system for supporting web multi-tasking without blocking the web browser screen in response to each user's web based accessing, which comprises acts:
k) deploying a lock for protecting a user space task list; and
l) repeating in a loop for receiving and parsing one or more requests from each user's web browser, and for each parsed request performing the following steps:
m) acquiring the lock that protects the user space task list, storing the task information into a valid entry of the user space task list; then releasing the lock after storing;
n) running the task into background to be distributed to and executed on one or more targeted systems of the virtual server;
o) updated mirrored virtual server MLIL in memory and providing a response web page including the updated mirrored MLIL and the task's status back to the corresponding user's web browser without waiting the completion of the task; and
p) cleaning up the task information in the corresponding entry of the user space task list in response to the completion of the task.

7. The method of claim 6, wherein said act o) further comprises act of
obtaining the task status from the control system if the control system is a targeted system, and obtaining the task status from a system bellow the control system if said system is a targeted system.

8. The method of claim 1, wherein said act e) further comprises act of
facilitating privileged user performing tasks of set access control via web MLIL for assigning one or more control systems including top and middle control system to each designated user's security profile for permitting the designated user accessing each control system and the service pool which controlled by the control system.

9. The method of claim 1, wherein said act e) further comprises act of:
facilitating and validating each user via the web MLIL only accessing or managing each of permitted one or more control system and one or more systems in each service pool which controlled by the control system.

10. A control system providing a web folder tree for managing and accessing a global virtual server, the control system comprises:
at least a CPU and multi-layered item lists (“MLIL”) memories,
a control management for communicating to the service agent of each system unit and each host to control automatic forming the virtual server with one or multiple service pools including storage pool and host service pool across a network infrastructure, and organizing the information of the virtual server as a MLIL, and
a web server interface coupled to the control management for providing web services and user interfaces (“UI”) including the virtual server MLIL for facilitating a plurality of users web based accessing and managing the virtual server; wherein
the control system controls displaying the virtual server MLIL into each user's web browser on the user's local system in response to the user's log on the control system, and updating the virtual server MLIL in each user's web browser and in memories in response to the user's each interactive accessing and managing the virtual server via the virtual server MLIL.

11. A virtual server providing a web folder tree for facilitating users managing its global resources, the virtual server comprises:
a plurality of system units and hosts, each one having service agent and providing services,
at least a console system having web browser for operating the virtual server,
a control system comprises multi-layered item list (“MLIL”) memories; wherein the control system
communicates to each system unit and each host to control automatic forming the virtual server with multiple service pools including storage pool and host service pool across a network infrastructure, and is capable of organizing the information of the virtual server as a MLIL, and
provides web services and user interfaces (“UI”) including the virtual server MLIL in response to a plurality of users web based accessing and managing the virtual server; and wherein the control system
controls displaying the virtual server MLIL into each user's web browser on the user's local system in response to the user's log on the control system, and
controls updating the virtual server MLIL in each user's web browser in response to the user's each interactive accessing and managing the permitted data or hardware resources of the virtual server via the virtual server MLIL.

12. The virtual server of claim 11, wherein said control system further comprises:
a control management for controlling automatic forming one or more service pools of the virtual server across a network, which is one of corporate Intranet, Internet, LAN or WAN, based on group ID or type of each system unit and host, wherein said service pool includes file server pool, video server pool, SAN block data server pool, NAS server pool, email server pool, and web server pool.

13. The virtual server of claim 12, wherein said control system further comprises:
a web server interface coupled to the control management capable of creating a MLIL for representing the virtual server, creating a mirrored MLIL for said MLIL in the memory of the control system for each user accessing one or more resources related to the MLIL in response to the user's entire accessing session.

14. The virtual server of claim 13 further comprises:
the web server interface coupled to the control management capable of providing web services and UI to include the virtual server MLIL for user accessing; distributing one or more requests including the request submitted from each user's web browser to one or more targeted systems for executing, and controlling the user's web browser submitted one or more tasks to be run without blocking the web browser screen.

15. The virtual server of claim 12 further includes:
providing service agent of each system unit via communicating to the control management of the control system for receiving, executing and responding to each request distributed from the control system; and capable of providing a specific type of service to at least a client system independent of the control system and other system unit.

16. The virtual server of claim 12 further includes:
providing service agent of each host via communicating to the control management of the control system capable for receiving, executing and responding to each request distributed from the control system, and capable of providing a specific type of service to at least a client system independent of the control system and other hosts.

17. The virtual server of claim 11, wherein said control automatic forming the virtual server with multiple service pools further comprises:
organizing multiple service pools of the virtual server into a multi-layered structure, where each service pool at each layer is controlled by and accessed via either a top control system or a middle control system, wherein each control system is capable of providing web folder tree.

18. The virtual server of claim 17 further comprises:
instructing the top control system creating a web MLIL for representing the entire virtual server and facilitating different privileged user via the web MLIL capable of accessing or managing permitted resources of the virtual server starting from the top control system down to one or more levels.

19. The virtual server of claim 17 further comprises:
instructing the middle control system creating a web MLIL for representing a service pool under its control and facilitating different privileged user via the web MLIL capable of accessing or managing permitted resources of the service pool starting from the middle control system down to one or more lower levels.

20. The virtual server of claim 17 further comprises:
configuring the middle control system to have the control management and web server interface software modules that the same as the top control system possessing, and having service agent modules that the same as the system unit or host possessing, therefore, the middle control system is capable of functioning as both the control system and the system unit.

21. The virtual server of claim 11, wherein said accessing permitted data or hardware resources further comprises:
facilitating privileged user performing tasks of set access control including performing said task via web NLIL for permitting one or more users accessing one or more said data or hardware resources of the virtual server; and
validating each user only accessing the permitted resources of the virtual server.
